(19) United States
(12) Patent Application Publication
(10) Pub. No.: US 2005/0266391 A1
(43) Pub. Date: Dec. 1, 2005

(54) Methods for preserving tissue

(76) Inventors: Brydon L. Bennett, San Diego, CA (US); David A. Brenner, New York, NY (US); Jerome B. Zeldis, Princeton, NJ (US)

Correspondence Address: JONES DAY, 222 EAST 41ST ST, NEW YORK, NY, 10017, US

(21) Appl. No.: 11/035,842

(22) Filed: Jan. 14, 2005

Related U.S. Application Data
(60) Provisional application No. 60/537,353, filed on Jan. 15, 2004.

(51) Int. Cl. A01N 1/00

(52) U.S. Cl. 435/1.1; 514/406

(57) ABSTRACT

The invention generally relates to methods for preserving tissue, preventing reperfusion injury to implanted tissue, preventing transplant rejection or preserving a cell to be transplanted, comprising contacting tissue or a cell with an effective amount of a JNK Inhibitor. The invention further relates to compositions useful for the preservation of tissue, the compositions comprising an effective amount of a JNK Inhibitor.

This application claims the benefit of U.S. provisional application No. 60/537,353, filed Jan. 15, 2004, the contents of which are incorporated by reference herein in their entirety.

### 1. FIELD OF INVENTION

The invention generally relates to methods for preserving tissue, preventing reperfusion injury to implanted tissue, preventing surgically-induced ischemia-reperfusion injury, preventing transplant rejection or preserving a cell to be implanted, comprising contacting the tissue or a cell with an effective amount of a c-Jun N-terminal kinase (“JNK”) Inhibitor. The invention further relates to compositions comprising an effective amount of a JNK Inhibitor.

### 2. BACKGROUND OF THE INVENTION

2.1 Ischemia-Reperfusion Injury

Ischemia-reperfusion injury is a not infrequent cause of clinical crisis. It can occur spontaneously as in myocardial infarction, stroke, and embolism or it can occur as a consequence of surgery such as blood vessel clamping, coronary artery bypass graft (CABG), angioplasty or transplant. The blockade of blood flow and oxygen distribution (ischemia) followed by rapid restoration (reperfusion) leads to tissue injury. Three major mechanisms promote tissue damage following ischemia-reperfusion injury. These are: 1) adverse changes in metabolite concentrations; 2) formation of reactive oxygen species; and 3) the acute inflammatory response (Wright A R and Rees S A, Trends in Pharmaceutical Sciences 18:224-228 (1997); Carden D L and Granger D N, Journal of Pathology 190:255-266 (2000)). During ischemia, the cells/tissues are in a hypoxic environment leading to rapid depletion of cellular ATP because of a switch-off of aerobic metabolism and oxidative phosphorylation by the electron transport chain in mitochondria. The switch to anaerobic metabolism (glycolysis) leads to a build-up in toxic by-products including lactate, carbonic acid (CO₂) and inorganic phosphates that lower the pH of the tissue. Upon reperfusion and reoxygenation, sudden and extreme changes occur in the physicochemical environment. The hyperosmotic extracellular environment formed during ischemia is suddenly diluted resulting in cell swelling, membrane rupture and necrosis. This releases highly antigenic cell contents into the interstitial space that initiate an acute inflammatory response. Uncoupling of the electron transport chain means oxygen is now converted to reactive oxygen species (ROS) (e.g., superoxide.ROS) which are highly reactive and directly oxidize proteins, lipids and nucleic acids. The process of apoptotic damage can progress through a tissue over hours or even days although the initiating events occur within seconds of reperfusion.

JNK is a stress-activated protein kinase that is turned on in response to physical, chemical and biological stresses. In ischemia-reperfusion injury, activated JNK is rapidly detectable upon reperfusion in multiple tissues including liver, lung, heart, kidney and brain (Bradham et al., Hepatology 25:1128-1135 (1997); Hreniuk et al., Molecular Pharmacology 59:867-874 (2001); Ishii et al., Journal of Immunology 172:2569-2577 (2004)).

2.2 Tissue Preservation

Tissue preservation is a critical aspect of organ transplantation. Tissue preservation provides much needed time to transport the organ, often across the country, to the recipient that is best tissue typed and matched for the organ or to the recipient with the greatest need for a transplant. Accordingly, there is an urgent need for methods that lengthen the duration of safe tissue preservation. The most common current procedures for preserving organs, as described below, are the manipulation of temperature and the use of agents that counteract osmotic flux.

Prior art methods for tissue preservation have been based upon suppressing metabolism of the organ under hypothermia. Southard and Belzer, Annu. Rev. Med. 46:235-247 (1995). In these methods, tissues are made tolerant to hypothermia by replacing the blood with a hypothermic preservation solution. Id.

The University of Wisconsin solution (the “UW solution”) is considered to be the most effective organ-preservation solution. Collins, Transplantation Proceedings 29:3543-3544 (1997). However, there are a number of standard solutions currently used in transplantation procedures such as St. Thomas's solution, Celsior solution, Stanford solution, Collins solution, Bretschneider's solution and Roe's solution, as well as variations and modifications of each. Huddleston and Mendeloff, J. Card. Surg. 15:108-121 (2000). Cardioplegia solutions are also currently used to prevent reperfusion injury during coronary artery bypass graft surgery.

The UW solution is thought to be effective because it contains cell-impermeant agents such as lactobionic acid, raffinose and hydroxyethyl starch that prevent cell swelling during cold ischemic storage. Southard and Belzer, supra.

Unfortunately, the length of time in which organs can be successfully preserved using prior-art methods remains inadequate. Currently, the liver, pancreas and kidney can be successfully preserved for approximately only two days by flushing the organs with the UW solution and storing at about 0-5° C. Southard and Belzer, supra.

Heart and lung transplants are unique in that they require immediate function for recipient survival. Thus, sufficient preservation time to determine donor-recipient compatibility is critical. Unfortunately, prior-art preservation techniques for heart and lung transplantation allow for only a 4-6 hour period of safe storage. Conte and Baumgartner, Cardiac and Pulmonary Preservation 15:91-107 (2000).

Accordingly, there is a clear need for improved methods for preserving tissue, for example, prior to transplantation.

Citation of any reference in Section 2 of this application is not an admission that the reference is prior art to the application.

### 3. SUMMARY OF THE INVENTION

In one embodiment, the invention relates to methods for preserving tissue, comprising contacting ex vivo tissue with an effective amount of a JNK Inhibitor.

In another embodiment, the invention relates to methods for preventing reperfusion injury to implanted tissue, comprising: (a) contacting tissue with an effective amount of a JNK Inhibitor; and (b) implanting the contacted tissue in a recipient.

In another embodiment, the invention relates to methods for preventing transplant rejection, comprising: (a) administering to a transplant recipient in need thereof an effective amount of a JNK Inhibitor; and (b) transplanting tissue in a recipient.

In another embodiment, the invention relates to methods for preserving tissue, comprising: (a) administering an effective amount of a JNK Inhibitor to a tissue donor; and (b) removing the tissue from the donor.

In another embodiment, the invention relates to a composition comprising ex vivo tissue and an effective amount of a JNK Inhibitor.

In another embodiment, the invention relates to a method for preventing ischemia-reperfusion injury that occurs during or as a result of surgery or trauma from accident comprising administering an effective amount of a JNK Inhibitor to a patient in need thereof.

In another embodiment, the invention relates to a container containing ex vivo tissue and an effective amount of a JNK Inhibitor.

In another embodiment, the invention relates to methods for preserving a cell to be implanted, comprising: (a) contacting a cell with an effective amount of a JNK Inhibitor; and (b) implanting the contacted cell in a recipient.

In another embodiment, the invention relates to methods for preserving an organ to be implanted, comprising: (a) contacting an organ with an effective amount of a JNK Inhibitor; and (b) implanting the contacted organ in a recipient.

3.1 Definitions

As used herein, the term “donor” or “recipient” means an animal (e.g., cow, horse, sheep, pig, chicken, turkey, quail, cat, dog, mouse, rat, rabbit or guinea pig), preferably a mammal such as a non-primate and a primate (e.g., monkey and human), most preferably a human. In one embodiment, the donor has brain-death. In another embodiment, that donor has brain-death and is kept alive by an artificial life-support system(s). In another embodiment, the donor is alive (e.g., a kidney or liver donor). In another embodiment, the donor and recipient are the same.

“Alkyl” means a saturated straight chain or branched non-cyclic hydrocarbon having from 1 to 10 carbon atoms. “Lower alkyl” means alkyl, as defined above, having from 1 to 4 carbon atoms. Representative saturated straight chain alkyls include -methyl, -ethyl, -n-propyl, -n-butyl, -n-pentyl, -n-hexyl, -n-heptyl, -n-octyl, -n-nonyl and -n-decyl; while saturated branched alkyls include -isopropyl, -sec-butyl, -isobutyl, -tert-butyl, -isopentyl, 2-methylbutyl, 3-methylbutyl, 2-methylpentyl, 3-methylpentyl, 4-methylpentyl, 2-methylhexyl, 3-methylhexyl, 4-methylhexyl, 5-methylhexyl, 2,3-dimethylbutyl, 2,3-dimethylpentyl, 2,4-dimethylpentyl, 2,3-dimethylhexyl, 2,4-dimethylhexyl, 2,5-dimethylhexyl, 2,2-dimethylpentyl, 2,2-dimethylhexyl, 3,3-dimtheylpentyl, 3,3-dimethylhexyl, 4,4-dimethylhexyl, 2-ethylpentyl, 3-ethylpentyl, 2-ethylhexyl, 3-ethylhexyl, 4-ethylhexyl, 2-methyl-2-ethylpentyl, 2-methyl-3-ethylpentyl, 2-methyl-4-ethylpentyl, 2-methyl-2-ethylhexyl, 2-methyl-3-ethylhexyl, 2-methyl-4-ethylhexyl, 2,2-diethylpentyl, 3,3-diethylhexyl, 2,2-diethylhexyl, 3,3-diethylhexyl and the like.

An “alkenyl group” or “alkylidene” mean a straight chain or branched non-cyclic hydrocarbon having from 2 to 10 carbon atoms and including at least one carbon-carbon double bond. Representative straight chain and branched (C₂-C₁₀)alkenyls include -vinyl, -allyl, -1-butenyl, -2-butenyl, -isobutylenyl, -1-pentenyl, -2-pentenyl, -3-methyl-1-butenyl, -2-methyl-2-butenyl, -2,3-dimethyl-2-butenyl, -1-hexenyl, -2-hexenyl, -3-hexenyl, -1-heptenyl, -2-heptenyl, -3-heptenyl, -1-octenyl, -2-octenyl, -3-octenyl, -1-nonenyl, -2-nonenyl, -3-nonenyl, -1-decenyl, -2-decenyl, -3-decenyl and the like. An alkenyl group can be unsubstituted or substituted. A “cyclic alkylidene” is a ring having from 3 to 8 carbon atoms and including at least one carbon-carbon double bond, wherein the ring can have from 1 to 3 heteroatoms.

An “alkynyl group” means a straight chain or branched non-cyclic hydrocarbon having from 2 to 10 carbon atoms and including at least one carbon-carbon triple bond. Representative straight chain and branched —(C₂-C₁₀)alkynyls include -acetylenyl, -propynyl, -1-butynyl, -2-butynyl, -1-pentynyl, -2-pentynyl, -3-methyl-1-butynyl, -4-pentynyl, -1-hexynyl, -2-hexynyl, -5-hexynyl, -1-heptynyl, -2-heptynyl, -6-heptynyl, -1-octynyl, -2-octynyl, -7-octynyl, -1-nonynyl, -2-nonynyl, -8-nonynyl, -1-decynyl, -2-decynyl, -9-decynyl, and the like. An alkynyl group can be unsubstituted or substituted.

The terms “Halogen” and “Halo” mean fluorine, chlorine, bromine or iodine.

“Haloalkyl” means an alkyl group, wherein alkyl is defined above, substituted with one or more halogen atoms.

“Keto” means a carbonyl group (i.e., C═O).

“Acyl” means an —C(O)alkyl group, wherein alkyl is defined above, including —C(O)CH₃, —C(O)CH₂CH₃, —C(O)(CH₂)₂CH₃, —C(O)(CH₂)₃CH₃, —C(O)(CH₂)₄CH₃, —C(O)(CH₂)₅CH₃, and the like.

“Acyloxy” means an —OC(O)alkyl group, wherein alkyl is defined above, including —OC(O)CH₃, —OC(O)CH₂CH₃, —OC(O)(CH₂)₂CH₃, —OC(O)(CH₂)₃CH₃, —OC(O)(CH₂)₄CH₃, —OC(O)(CH₂)₅CH₃, and the like.

“Ester” or “Alkoxyalkoxy” mean a —C(O)Oalkyl group, wherein alkyl is defined above, including —C(O)OCH₃, —C(O)OCH₂CH₃, —C(O)O(CH₂)₂CH₃, —C(O)O(CH₂)₃CH₃, —C(O)O(CH₂)₄CH₃, —C(O)O(CH₂)₅CH₃, and the like.

“Alkoxy” means —O-(alkyl), wherein alkyl is defined above, including —OCH₃, —OCH₂CH₃, —O(CH₂)₂CH₃, —O(CH₂)₃CH₃, —O(CH₂)₄CH₃, —O(CH₂)₅CH₃, and the like.

“Lower alkoxy” means —O-(lower alkyl), wherein lower alkyl is as described above.

“Alkoxycarbonyl” means —C(═O)O-(alkyl), wherein alkyl is defined above, including —C(═O)O—CH₃, —C(═O)O—CH₂CH₃, —C(═O)O—(CH₂)₂CH₃, —C(═O)O—(CH₂)₃CH₃, —C(═O)O—(CH₂)₄CH₃, —C(═O)O—(CH₂)₅CH₃, and the like.

“Alkoxycarbonylalkyl” means -(alkyl)-C(═O)O-(alkyl), wherein each alkyl is independently defined above, including —CH₂—C(═O)O—CH₃, —CH₂—C(═O)O—CH₂CH₃, —CH₂—C(═O)O—(CH₂)₂CH₃, —CH₂—C(═O)O—(CH₂)₃CH₃, —CH₂—C(═O)O—(CH₂)₄CH₃, —CH₂—C(═O)O—(CH₂)₅CH₃, and the like.

“Alkoxyalkyl” means -(alkyl)-O-(alkyl), wherein each alkyl is independently an alkyl group as defined above, including —CH₂OCH₃, —CH₂OCH₂CH₃, —(CH₂)₂OCH₂CH₃, —(CH₂)₂O(CH₂)₂CH₃, and the like.

“Aryl” means a carbocyclic aromatic group containing from 5 to 10 ring atoms. Representative examples include, but are not limited to, phenyl, tolyl, anthracenyl, fluorenyl, indenyl, azulenyl, pyridinyl and naphthyl, as well as benzo-fused carbocyclic moieties including 5,6,7,8-tetrahydronaphthyl. A carbocyclic aromatic group can be unsubstituted or substituted. In one embodiment, the carbocyclic aromatic group is a phenyl group.

“Aryloxy” means —O-aryl group, wherein aryl is as defined above. An aryloxy group can be unsubstituted or substituted. In one embodiment, the aryl ring of an aryloxy group is a phenyl group “Arylalkyl” means -(alkyl)-(aryl), wherein alkyl and aryl are as defined above, including —(CH₂)phenyl, —(CH₂)₂phenyl, —(CH₂)₃phenyl, —CH(phenyl)₂, —CH(phenyl)₃, —(CH₂)tolyl, —(CH₂)anthracenyl, —(CH₂)fluorenyl, —(CH₂)indenyl, —(CH₂)azulenyl, —(CH₂)pyridinyl, —(CH₂)naphthyl, and the like.

“Arylalkyloxy” means —O-(alkyl)-(aryl), wherein alkyl and aryl are defined above, including —O—(CH₂)₂phenyl, —O—(CH₂)₃phenyl, —O—CH(phenyl)₂, —O—CH(phenyl)₃, —O—(CH₂)tolyl, —O—(CH₂)anthracenyl, —O—(CH₂)fluorenyl, —O—(CH₂)indenyl, —O—(CH₂)azulenyl, —O—(CH₂)pyridinyl, —O—(CH₂)naphthyl, and the like.

“Aryloxyalkyl” means -(alkyl)-O-(aryl), wherein alkyl and aryl are defined above, including —CH₂—O-(phenyl), —(CH₂)₂—O-phenyl, —(CH₂)₃—O-phenyl, —(CH₂)—O-tolyl, —(CH₂)—O-anthracenyl, —(CH₂)—O-fluorenyl, —(CH₂)—O-indenyl, —(CH₂)—O-azulenyl, —(CH₂)—O-pyridinyl, —(CH₂)—O-naphthyl, and the like.

“Cycloalkyl” means a monocyclic or polycyclic saturated ring having carbon and hydrogen atoms and having no carbon-carbon multiple bonds. Examples of cycloalkyl groups include, but are not limited to, (C₃-C₇)cycloalkyl groups, including cyclopropyl, cyclobutyl, cyclopentyl, cyclohexyl, and cycloheptyl, and saturated cyclic and bicyclic terpenes. A cycloalkyl group can be unsubstituted or substituted. In one embodiment, the cycloalkyl group is a monocyclic ring or bicyclic ring.

“Cycloalkyloxy” means —O-(cycloalkyl), wherein cycloalkyl is defined above, including —O-cyclopropyl, —O-cyclobutyl, —O-cyclopentyl, —O-cyclohexyl, —O-cycloheptyl and the like.

“Cycloalkylalkyloxy” means —O-(alkyl)-(cycloalkyl), wherein cycloalkyl and alkyl are defined above, including —O—CH₂-cyclopropyl, —O—(CH₂)₂-cyclopropyl, —O—(CH₂)₃-cyclopropyl, —O—(CH₂)₄-cyclopropyl, O—CH₂-cyclobutyl, O—CH₂-cyclopentyl, O—CH₂-cyclohexyl, O—CH₂-cycloheptyl, and the like.

“Aminoalkoxy” means —O-(alkyl)-NH₂, wherein alkyl is defined above, such as —O—CH₂—NH₂, —O—(CH₂)₂—NH₂, —O—(CH₂)₃—NH₂, —O—(CH₂)₄—NH₂, —O—(CH₂)₅—NH₂, and the like.

“Mono-alkylamino” means —NH(alkyl), wherein alkyl is defined above, such as —NHCH₃, —NHCH₂CH₃, —NH(CH₂)₂CH₃, —NH(CH₂)₃CH₃, —NH(CH₂)₄CH₃, —NH(CH₂)₅CH₃, and the like.

“Di-alkylamino” means —N(alkyl)(alkyl), wherein each alkyl is independently an alkyl group as defined above, including —N(CH₃)₂, —N(CH₂CH₃)₂, —N((CH₂)₂CH₃)₂, —N(CH₃)(CH₂CH₃), and the like.

“Mono-alkylaminoalkoxy” means —O-(alkyl)-NH(alkyl), wherein each alkyl is independently an alkyl group as defined above, including —O—(CH₂)—NHCH₃, —O—(CH₂)—NHCH₂CH₃, —O—(CH₂)—NH(CH₂)₂CH₃, —O—(CH₂)—NH(CH₂)₃CH₃, —O—(CH₂)—NH(CH₂)₄CH₃, —O—(CH₂)—NH(CH₂)₅CH₃, —O—(CH₂)₂—NHCH₃, and the like.

“Di-alkylaminoalkoxy” means —O-(alkyl)-N(alkyl)(alkyl), wherein each alkyl is independently an alkyl group as defined above, including —O—(CH₂)—N(CH₃)₂, —O—(CH₂)—N(CH₂CH₃)₂, —O—(CH₂)—N((CH₂)₂CH₃)₂, —O—(CH₂)—N(CH₃)(CH₂CH₃), and the like.

“Arylamino” means —NH(aryl), wherein aryl is defined above, including —NH(phenyl), —NH(tolyl), —NH(anthracenyl), —NH(fluorenyl), —NH(indenyl), —NH(azulenyl), —NH(pyridinyl), —NH(naphthyl), and the like.

“Arylalkylamino” means —NH-(alkyl)-(aryl), wherein alkyl and aryl are defined above, including —NH—CH₂— (phenyl), —NH—CH₂— (tolyl), —NH—CH₂— (anthracenyl), —NH—CH₂— (fluorenyl), —NH—CH₂— (indenyl), —NH—CH₂— (azulenyl), —NH—CH₂— (pyridinyl), —NH—CH₂— (naphthyl), —NH—(CH₂)₂-(phenyl) and the like.

“Alkylamino” means mono-alkylamino or di-alkylamino as defined above, such as —NH(alkyl), wherein each alkyl is independently an alkyl group as defined above, including —NHCH₃, —NHCH₂CH₃, —NH(CH₂)₂CH₃, —NH(CH₂)₃CH₃, —NH(CH₂)₄CH₃, —NH(CH₂)₅CH₃, and —N(alkyl)(alkyl), wherein each alkyl is independently an alkyl group as defined above, including —N(CH₃)₂, —N(CH₂CH₃)₂, —N((CH₂)₂CH₃)₂, —N(CH₃)(CH₂CH₃) and the like.

“Cycloalkylamino” means —NH-(cycloalkyl), wherein cycloalkyl is as defined above, including —NH-cyclopropyl, —NH-cyclobutyl, —NH-cyclopentyl, —NH-cyclohexyl, —NH-cycloheptyl, and the like.

“Carboxyl” and “carboxy” mean —COOH.

“Cycloalkylalkylamino” means —NH-(alkyl)-(cycloalkyl), wherein alkyl and cycloalkyl are defined above, including —NH—CH₂-cyclopropyl, —NH—CH₂-cyclobutyl, —NH—CH₂-cyclopentyl, —NH—CH₂-cyclohexyl, —NH—CH₂-cycloheptyl, —NH—(CH₂)₂-cyclopropyl and the like.

“Aminoalkyl” means -(alkyl)-NH₂, wherein alkyl is defined above, including CH₂—NH₂, —(CH₂)₂—NH₂, —(CH₂)₃—NH₂, —(CH₂)₄—NH₂, —(CH₂)₅—NH₂ and the like.

“Mono-alkylaminoalkyl” means -(alkyl)-NH(alkyl),wherein each alkyl is independently an alkyl group defined above, including —CH₂—NH—CH₃, —CH₂—NHCH₂CH₃, —CH₂—NH(CH₂)₂CH₃, —CH₂—NH(CH₂)₃CH₃, —CH₂—NH(CH₂)₄CH₃, —CH₂—NH(CH₂)₅CH₃, —(CH₂)₂—NH—CH₃, and the like.

“Di-alkylaminoalkyl” means -(alkyl)-N(alkyl)(alkyl),wherein each alkyl is independently an alkyl group defined above, including —CH₂—N(CH₃)₂, —CH₂—N(CH₂CH₃)₂, —CH₂—N((CH₂)₂CH₃)₂, —CH₂—N(CH₃)(CH₂CH₃), —(CH₂)₂—N(CH₃)₂, and the like.

“Heteroaryl” means an aromatic heterocycle ring of 5- to 10 members and having at least one heteroatom selected from nitrogen, oxygen and sulfur, and containing at least 1 carbon atom, including both mono- and bicyclic ring systems. Representative heteroaryls are triazolyl, tetrazolyl, oxadiazolyl, pyridyl, furyl, benzofuranyl, thiophenyl, benzothiophenyl, quinolinyl, pyrrolyl, indolyl, oxazolyl, benzoxazolyl, imidazolyl, benzimidazolyl, thiazolyl, benzothiazolyl, isoxazolyl, pyrazolyl, isothiazolyl, pyridazinyl, pyrimidinyl, pyrazinyl, triazinyl, cinnolinyl, phthalazinyl, quinazolinyl, pyrimidyl, oxetanyl, azepinyl, piperazinyl, morpholinyl, dioxanyl, thietanyl and oxazolyl.

“Heteroarylalkyl” means -(alkyl)-(heteroaryl), wherein alkyl and heteroaryl are defined above, including —CH₂-triazolyl, —CH₂-tetrazolyl, —CH₂-oxadiazolyl, —CH₂-pyridyl, —CH₂-furyl, —CH₂-benzofuranyl, —CH₂-thiophenyl, —CH₂-benzothiophenyl, —CH₂-quinolinyl, —CH₂-pyrrolyl, —CH₂-indolyl, —CH₂-oxazolyl, —CH₂-benzoxazolyl, —CH₂-imidazolyl, —CH₂-benzimidazolyl, —CH₂-thiazolyl, —CH₂-benzothiazolyl, —CH₂-isoxazolyl, —CH₂-pyrazolyl, —CH₂-isothiazolyl, —CH₂-pyridazinyl, —CH₂-pyrimidinyl, —CH₂-pyrazinyl, —CH₂-triazinyl, —CH₂-cinnolinyl, —CH₂-phthalazinyl, —CH₂-quinazolinyl, —CH₂-pyrimidyl, —CH₂-oxetanyl, —CH₂-azepinyl, —CH₂-piperazinyl, —CH₂-morpholinyl, —CH₂-dioxanyl, —CH₂-thietanyl, —CH₂-oxazolyl, —(CH₂)₂-triazolyl, and the like.

“Heterocycle” means a 5- to 7-membered monocyclic, or 7- to 10-membered bicyclic, heterocyclic ring which is either saturated, unsaturated, and which contains from 1 to 4 heteroatoms independently selected from nitrogen, oxygen and sulfur, and wherein the nitrogen and sulfur heteroatoms can be optionally oxidized, and the nitrogen heteroatom can be optionally quaternized, including bicyclic rings in which any of the above heterocycles are fused to a benzene ring. The heterocycle can be attached via any heteroatom or carbon atom. Heterocycles include heteroaryls as defined above. Representative heterocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

“Heterocycle fused to phenyl” means a heterocycle, wherein heterocycle is defined as above, that is attached to a phenyl ring at two adjacent carbon atoms of the phenyl ring.

“Heterocycloalkyl” means -(alkyl)-(heterocycle), wherein alkyl and heterocycle are defined above, including —CH₂-morpholinyl, —CH₂-pyrrolidinonyl, —CH₂-pyrrolidinyl, —CH₂-piperidinyl, —CH₂-hydantoinyl, —CH₂-valerolactamyl, —CH₂-oxiranyl, —CH₂-oxetanyl, —CH₂-tetrahydrofuranyl, —CH₂-tetrahydropyranyl, —CH₂-tetrahydropyridinyl, —CH₂-tetrahydroprimidinyl, —CH₂-tetrahydrothiophenyl, —CH₂-tetrahydrothiopyranyl, —CH₂-tetrahydropyrimidinyl, —CH₂-tetrahydrothiophenyl, —CH₂-tetrahydrothiopyranyl, and the like.

The term “substituted” as used herein means any of the above groups (i.e., aryl, arylalkyl, heterocycle and heterocycloalkyl) wherein at least one hydrogen atom of the moiety being substituted is replaced with a substituent. In one embodiment, each carbon atom of the group being substituted is substituted with no more that two substituents. In another embodiment, each carbon atom of the group being substituted is substituted with no more than one substituent. In the case of a keto substituent, two hydrogen atoms are replaced with an oxygen which is attached to the carbon via a double bond. Substituents include halogen, hydroxyl, alkyl, haloalkyl, mono- or di-substituted aminoalkyl, alkyloxyalkyl, aryl, arylalkyl, heterocycle, heterocycloalkyl, —NRₐR_{b}, —NRₐC(═O)R_{b}, —NRₐC(═O)NRₐR_{b}, —NRₐC(═O)OR_{b}—NRₐSO₂R_{b}, —ORₐ, —C(═O)Rₐ C(═O)ORₐ —C(═O)NRₐR_{b}, —OC(═O)Rₐ, —OC(═O)ORₐ, —OC(═O)NRₐR_{b}, —NRₐSO₂R_{b}, or a radical of the formula -Y-Z-Rₐ where Y is alkanediyl, or a direct bond, Z is —O—, —S—, —N(R_{b})—, —C(═O)—, —C(═O)O—, —OC(═O)—, —N(R_{b})C(═O)—, —C(═O)N(R_{b})— or a direct bond, wherein Rₐ and R_{b} are the same or different and independently hydrogen, amino, alkyl, haloalkyl, aryl, arylalkyl, heterocycle, or heterocylealkyl, or wherein Rₐ and R_{b} taken together with the nitrogen atom to which they are attached form a heterocycle.

“Haloalkyl” means alkyl, wherein alkyl is defined as above, having one or more hydrogen atoms replaced with halogen, wherein halogen is as defined above, including —CF₃, —CHF₂, —CH₂F, —CBr₃, —CHBr₂, —CH₂Br, —CCl₃, —CHCl₂, —CH₂Cl, —Cl₃, —CH₁₂, —CH₂I, —CH₂—CF₃, —CH₂—CHF₂, —CH₂—CH₂F, —CH₂—CBr₃, —CH₂—CHBr₂, —CH₂—CH₂Br, —CH₂—CCl₃, —CH₂—CHCl₂, —CH₂—CH₂Cl, —CH₂—Cl₃, —CH₂—CH₁₂, —CH₂—CH₂I, and the like.

“Hydroxyalkyl” means alkyl, wherein alkyl is as defined above, having one or more hydrogen atoms replaced with hydroxy, including —CH₂OH, —CH₂CH₂OH, —(CH₂)₂CH₂OH, —(CH₂)₃CH₂OH, —(CH₂)₄CH₂OH, —(CH₂)₅CH₂OH, —CH(OH)—CH₃, —CH₂CH(OH)CH₃, and the like.

“Hydroxy” means —OH.

“Sulfonyl” means —SO₃H.

“Sulfonylalkyl” means —SO₂-(alkyl), wherein alkyl is defined above, including —SO₂—CH₃, —SO₂—CH₂CH₃, —SO₂—(CH₂)₂CH₃, —SO₂—(CH₂)₃CH₃, —SO₂—(CH₂)₄CH₃, —SO₂—(CH₂)₅CH₃, and the like.

“Sulfinylalkyl” means —SO-(alkyl), wherein alkyl is defined above, including —SO—CH₃, —SO—CH₂CH₃, —SO—(CH₂)₂CH₃, —SO—(CH₂)₃CH₃, —SO—(CH₂)₄CH₃, —SO—(CH₂)₅CH₃, and the like.

“Sulfonamidoalkyl” means —NHSO₂— (alkyl), wherein alkyl is defined above, including —NHSO₂—CH₃, —NHSO₂—CH₂CH₃, —NHSO₂—(CH₂)₂CH₃, —NHSO₂—(CH₂)₃CH₃, —NHSO₂—(CH₂)₄CH₃, —NHSO₂—(CH₂)₅CH₃, and the like.

“Thioalkyl” means —S-(alkyl), wherein alkyl is defined above, including —S—CH₃, —S—CH₂CH₃, —S—(CH₂)₂CH₃, —S—(CH₂)₃CH₃, —S—(CH₂)₄CH₃, —S—(CH₂)₅CH₃, and the like.

As used herein, the term “JNK Inhibitor” means a compound capable of inhibiting the activity of JNK in vitro or in vivo. The JNK Inhibitor can be in the form of a pharmaceutically acceptable salt, free base, solvate, hydrate, stereoisomer, clathrate, polymorph or prodrug thereof. Such inhibitory activity can be determined by an assay or animal model well-known in the art including those set forth in Section 5. In one embodiment, the JNK Inhibitor is a compound of structure (I)-(III) or a pharmaceutically acceptable salt, free base, solvate, hydrate, stereoisomer, clathrate, polymorph or prodrug thereof.

As used herein, the phrase “an effective amount of a JNK Inhibitor” is the amount of the JNK Inhibitor that is useful for preserving tissue, preventing reperfusion injury to implanted tissue, preventing transplant rejection or preserving a cell to be implanted. In one embodiment, the term “preserving” includes, but is not limited to, maintaining a cell, tissue or organ in its current state for an amount of time that is longer than would be achieved in the absence of a JNK Inhibitor. In another embodiment, the term “preserving” includes, but is not limited to, lengthening the time in which a cell, tissue or organ functions properly relative to that which would be achieved in the absence of a JNK Inhibitor. In another embodiment, the term “preserving” includes, but is not limited to, lengthening the time in which a cell, tissue or organ is useful for transplant relative to that which would be achieved in the absence of a JNK Inhibitor.

As used herein, the phrase “an effective amount” when used in connection with another tissue-preservation agent is an amount of the other tissue-preservation agent that is useful for preserving tissue, preventing reperfusion injury to implanted tissue, preventing transplant rejection or preserving a cell to be implanted, while the JNK Inhibitor is exerting its effect. In one embodiment, the term “preserving” includes, but is not limited to, maintaining a cell, tissue or organ in its current state for an amount of time that is longer than would be achieved in the absence of another tissue-preservation agent. In another embodiment, the term “preserving” includes, but is not limited to, lengthening the time in which a cell, tissue or organ functions properly relative to that which would be achieved in the absence of another tissue-preservation agent. In another embodiment, the term “preserving” includes, but is not limited to, lengthening the time in which a cell, tissue or organ is useful for transplant relative to that which would be achieved in the absence of a another tissue-preservation agent.

As used herein, the term “pharmaceutically acceptable salt(s)” refer to a salt prepared from a pharmaceutically acceptable non-toxic acid or base including an inorganic acid and base and an organic acid and base. Suitable pharmaceutically acceptable base addition salts for the compound of the present invention include, but are not limited to metallic salts made from aluminum, calcium, lithium, magnesium, potassium, sodium and zinc or organic salts made from lysine, N,N′-dibenzylethylenediamine, chloroprocaine, choline, diethanolamine, ethylenediamine, meglumine (N-methylglucamine) and procaine. Suitable non-toxic acids include, but are not limited to, inorganic and organic acids such as acetic, alginic, anthranilic, benzenesulfonic, benzoic, camphorsulfonic, citric, ethenesulfonic, formic, fumaric, furoic, galacturonic, gluconic, glucuronic, glutamic, glycolic, hydrobromic, hydrochloric, isethionic, lactic, maleic, malic, mandelic, methanesulfonic, mucic, nitric, pamoic, pantothenic, phenylacetic, phosphoric, propionic, salicylic, stearic, succinic, sulfanilic, sulfuric, tartaric acid, and p-toluenesulfonic acid. Specific non-toxic acids include hydrochloric, hydrobromic, phosphoric, sulfuric, and methanesulfonic acids. Examples of specific salts thus include hydrochloride and mesylate salts. Others are well-known in the art, see for example, Remington's Pharmaceutical Sciences, 18^{th} eds., Mack Publishing, Easton Pa. (1990) or Remington: The Science and Practice of Pharmacy, 19^{th} eds., Mack Publishing, Easton Pa. (1995).

As used herein and unless otherwise indicated, the term “polymorph” refers to solid crystalline forms of a JNK Inhibitor or complex thereof. Different polymorphs of the same compound can exhibit different physical, chemical and/or spectroscopic properties. Different physical properties include, but are not limited to stability (e.g., to heat or light), compressibility and density (important in formulation and product manufacturing), and dissolution rates (which can affect bioavailability). Differences in stability can result from changes in chemical reactivity (e.g., differential oxidation, such that a dosage form discolors more rapidly when comprised of one polymorph than when comprised of another polymorph) or mechanical characteristics (e.g., tablets crumble on storage as a kinetically favored polymorph converts to thermodynamically more stable polymorph) or both (e.g., tablets of one polymorph are more susceptible to breakdown at high humidity). Different physical properties of polymorphs can affect their processing. For example, one polymorph might be more likely to form solvates or might be more difficult to filter or wash free of impurities than another due to, for example, the shape or size distribution of particles of it.

As used herein, the term “hydrate” means a JNK Inhibitor or a salt thereof, that further includes a stoichiometric or non-stoichiometric amount of water bound by non-covalent intermolecular forces.

As used herein, he term “clathrate” means a JNK Inhibitor or a salt thereof in the form of a crystal lattice that contains spaces (e.g., channels) that have a guest molecule (e.g., a solvent or water) trapped within.

As used herein and unless otherwise indicated, the term “prodrug” means a JNK Inhibitor derivative that can hydrolyze, oxidize, or otherwise react under biological conditions (in vitro or in vivo) to provide an active compound, particularly a JNK Inhibitor. Examples of prodrugs include, but are not limited to, derivatives and metabolites of a JNK Inhibitor that include biohydrolyzable moieties such as biohydrolyzable amides, biohydrolyzable esters, biohydrolyzable carbamates, biohydrolyzable carbonates, biohydrolyzable ureides, and biohydrolyzable phosphate analogues. Preferably, prodrugs of compounds with carboxyl functional groups are the lower alkyl esters of the carboxylic acid. The carboxylate esters are conveniently formed by esterifying any of the carboxylic acid moieties present on the molecule. Prodrugs can typically be prepared using well-known methods, such as those described by Burger's Medicinal Chemistry and Drug Discovery 6^{th} ed. (Donald J. Abraham ed., 2001, Wiley) and Design and Application of Prodrugs (H. Bundgaard ed., 1985, Harwood Academic Publishers Gmfh).

As used herein and unless otherwise indicated, the term “optically pure”, “stereomerically pure” or “stereoisomer” means one stereoisomer of a compound is substantially free of other stereoisomers of that compound. For example, a stereomerically pure compound having one chiral center will be substantially free of the opposite enantiomer of the compound. A stereomerically pure a compound having two chiral centers will be substantially free of other diastereomers of the compound. A typical stereomerically pure compound comprises greater than about 80% by weight of one stereoisomer of the compound and less than about 20% by weight of other stereoisomers of the compound, more preferably greater than about 90% by weight of one stereoisomer of the compound and less than about 10% by weight of the other stereoisomers of the compound, even more preferably greater than about 95% by weight of one stereoisomer of the compound and less than about 5% by weight of the other stereoisomers of the compound, and most preferably greater than about 97% by weight of one stereoisomer of the compound and less than about 3% by weight of the other stereoisomers of the compound.

### 4. DETAILED DESCRIPTION OF THE INVENTION

4.1 JNK Inhibitors

Illustrative JNK Inhibitors are set forth below.

In one embodiment, the JNK Inhibitor has the following structure (I): 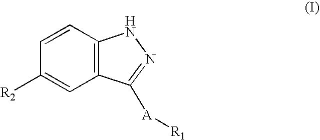
including stereoisomers, clathrates, solvates, prodrugs, polymorphs or pharmaceutically acceptable salts thereof,
wherein:
A is a direct bond, —(CH₂)ₐ—, —(CH₂)_{b}CH═CH(CH₂)_{c}—, or —(CH₂)_{b}C≡C(CH₂)_{c}—;
R₁ is aryl, heteroaryl or heterocycle fused to phenyl, each being optionally substituted with one to four substituents independently selected from R₃;
R₂ is —R₃, —R₄, —(CH₂)_{b}C(═O)R₅, —(CH₂)_{b}C(═O)OR₅, —(CH₂)_{b}C(═O)NR₅R₆, —(CH₂)_{b}C(═O)NR₅(CH₂)_{c}C(═O)R₆, —(CH₂)_{b}NR₅C(═O)R₆, —(CH₂)_{b}NR₅C(═O)NR₆R₇, —(CH₂)_{b}NR₅R₆, —(CH₂)_{b}OR₅, —(CH₂)_{b}SO_{d}R₅ or —(CH₂)_{b}SO₂NR₅R₆;
a is 1, 2, 3, 4, 5 or 6;
b and c are the same or different and at each occurrence independently selected from 0, 1, 2, 3 or 4;
d is at each occurrence 0, 1 or 2;
R₃ is at each occurrence independently halogen, hydroxy, carboxy, alkyl, alkoxy, haloalkyl, acyloxy, thioalkyl, sulfinylalkyl, sulfonylalkyl, hydroxyalkyl, aryl, arylalkyl, heterocycle, heterocycloalkyl, —C(═O)OR₈, —OC(═O)R₈, —C(═O)NR₈R₉, —C(═O)NR₈OR₉, —SO₂NR₈R₉, —NR₈SO₂R₉, —CN, —NO₂, —NR₈R₉, —NR₈C(═O)R₉, —NR₈C(═O)(CH₂)_{b}OR₉, —NR₈C(═O)(CH₂)_{b}R₉, NR₈C(═O)(CH₂)_{b}NR₈R₉, —O(CH₂)_{b}NR₈R₉, or heterocycle fused to phenyl;
R₄ is alkyl, aryl, arylalkyl, heterocycle or heterocycloalkyl, each being optionally substituted with one to four substituents independently selected from R₃, or R₄ is halogen or hydroxy;
R₅, R₆ and R₇ are the same or different and at each occurrence independently hydrogen, alkyl, aryl, arylalkyl, heterocycle or heterocycloalkyl, wherein each of R₅, R₆ and R₇ are optionally substituted with one to four substituents independently selected from R₃; and
R₈ and R₉ are the same or different and at each occurrence independently hydrogen, alkyl, aryl, arylalkyl, heterocycle, or heterocycloalkyl, or R₈ and R₉ taken together with the atom or atoms to which they are bonded form a heterocycle, wherein each of R₈, R₉, and R₈ and R₉ taken together to form a heterocycle are optionally substituted with one to four substituents independently selected from R₃.

In one embodiment, -A-R₁ is phenyl, optionally substituted with one to four substituents independently selected from halogen, alkoxy, —NR₈C(═O)R₉, —C(═O)NR₈R₉, and —O(CH₂)_{b}NR₈R₉, wherein b is 2 or 3 and wherein R₈ and R₉ are defined above.

In another embodiment, R₂ is —R₄, —(CH₂)_{b}C(═O)R₅, —(CH₂)_{b}C(═O)OR₅, —(CH₂)_{b}C(═O)NR₅R₆, —(CH₂)_{b}C(═O)NR₅(CH₂)_{c}C(═O)R₆, —(CH₂)_{b}NR₅C(═O)R₆, —(CH₂)_{b}NR₅C(═O)NR₆R₇, —(CH₂)_{b}NR₅R₆, —(CH₂)_{b}OR₅, —(CH₂)_{b}SO_{d}R₅ or —(CH₂)_{b}SO₂NR₅R₆, and b is an integer ranging from 0-4.

In another embodiment, R₂ is —(CH₂)_{b}C(═O)NR₅R₆, —(CH₂)_{b}NR₅C(═O)R₆, 3-triazolyl or 5-tetrazolyl, wherein b is 0 and wherein R₈ and R₉ are defined above.

In another embodiment, R₂ is 3-triazolyl or 5-tetrazolyl.

In another embodiment:
(a) -A-R₁ is phenyl, optionally substituted with one to four substituents independently selected from halogen, alkoxy, —NR₈C(═O)R₉, —C(═O)NR₈R₉,
and —O(CH₂)_{b}NR₈R₉, wherein b is 2 or 3; and
(b) R₂ is —(CH₂)_{b}C(═O)NR₅R₆, —(CH₂)_{b}NR₅C(═O)R₆, 3-triazolyl or 5-tetrazolyl, wherein b is 0 and wherein R₈ and R₉ are defined above.

In another embodiment:
(a) -A-R₁ is phenyl, optionally substituted with one to four substituents independently selected from halogen, alkoxy, —NR₈C(═O)R₉, —C(═O)NR₈R₉, and —O(CH₂)_{b}NR₈R₉, wherein b is 2 or 3; and
(b) R₂ is 3-triazolyl or 5-tetrazolyl.

In another embodiment, R₂ is R₄, and R₄ is 3-triazolyl, optionally substituted at its 5-position with:
(a) a C₁-C₄ straight or branched chain alkyl group optionally substituted with a hydroxyl, methylamino, dimethylamino or 1-pyrrolidinyl group; or
(b) a 2-pyrrolidinyl group.

In another embodiment, R₂ is R₄, and R₄ is 3-triazolyl, optionally substituted at its 5-position with: methyl, n-propyl, isopropyl, 1-hydroxyethyl, 3-hydroxypropyl, methylaminomethyl, dimethylaminomethyl, 1-(dimethylamino)ethyl, 1-pyrrolidinylmethyl or 2-pyrrolidinyl.

In another embodiment, the compounds of structure (I) have structure (IA) when A is a direct bond, or have structure (IB) when A is —(CH₂)ₐ—:

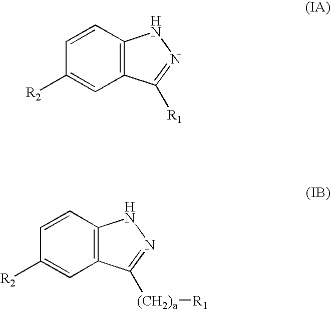

In other embodiments, the compounds of structure (I) have structure (IC) when A is a —(CH₂)_{b}CH═CH(CH₂)_{c}—, and have structure (ID) when A is —(CH₂)_{b}C≡C(CH₂)_{c}—:

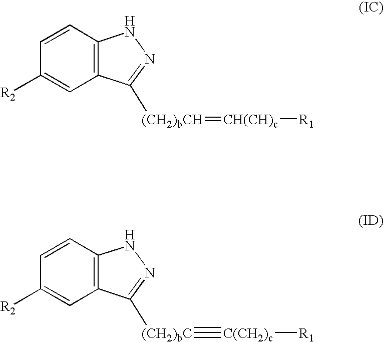

In further embodiments of this invention, R₁ of structure (I) is aryl or substituted aryl, such as phenyl or substituted phenyl as represented by the following structure (IE):

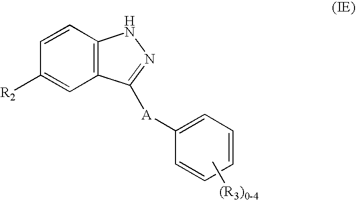

In another embodiment, R₂ of structure (I) is —(CH₂)_{b}NR₅(C═O)R₆. In one aspect of this embodiment, b=0 and the compounds have the following structure (IF):

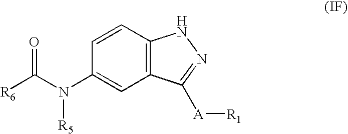

Representative R₂ groups of the compounds of structure (I) include alkyl (such as methyl and ethyl), halo (such as chloro and fluoro), haloalkyl (such as trifluoromethyl), hydroxy, alkoxy (such as methoxy and ethoxy), amino, arylalkyloxy (such as benzyloxy), mono- or di-alkylamine (such as —NHCH₃, —N(CH₃)₂ and —NHCH₂CH₃), —NHC(═O)R₆ wherein R₆ is a substituted or unsubstituted phenyl or heteroaryl (such as phenyl or heteroaryl substituted with hydroxy, carboxy, amino, ester, alkoxy, alkyl, aryl, haloalkyl, halo, —CONH₂ and —CONH alkyl), —NH(heteroarylalkyl) (such as —NHCH₂(3-pyridyl), —NHCH₂(4-pyridyl), heteroaryl (such as pyrazolo, triazolo and tetrazolo), —C(═O)NHR₆ wherein R₆ is hydrogen, alkyl, or as defined above (such as —C(═O)NH₂, —C(═O)NHCH₃, —C(═O)NH(H-carboxyphenyl), —C(═O)N(CH₃)₂), arylalkenyl (such as phenylvinyl, 3-nitrophenylvinyl, 4-carboxyphenylvinyl), heteroarylalkenyl (such as 2-pyridylvinyl, 4-pyridylvinyl).

Representative R₃ groups of the compounds of structure (I) include halogen (such as chloro and fluoro), alkyl (such as methyl, ethyl and isopropyl), haloalkyl (such as trifluoromethyl), hydroxy, alkoxy (such as methoxy, ethoxy, n-propyloxy and isobutyloxy), amino, mono- or di-alkylamino (such as dimethylamine), aryl (such as phenyl), carboxy, nitro, cyano, sulfinylalkyl (such as methylsulfinyl), sulfonylalkyl (such as methylsulfonyl), sulfonamidoalkyl (such as —NHSO₂CH₃), —NR₈C(═O)(CH₂)_{b}OR₉ (such as NHC(═O)CH₂OCH₃), NHC(═O)R₉ (such as —NHC(═O)CH₃, —NHC(═O)CH₂C₆H₅, —NHC(═O)(2-furanyl)), and —O(CH₂)_{b}NR₈R₉ (such as —O(CH₂)₂N(CH₃)₂).

The compounds of structure (I) can be made using organic synthesis techniques known to those skilled in the art, as well as by the methods described in International Publication No. WO 02/10137 (particularly in Examples 1-430, at page 35, line 1 to page 396, line 12), published Feb. 7, 2002, which is incorporated herein by reference in its entirety. Further, specific examples of these compounds are found in this publication.

Illustrative examples of JNK Inhibitors of structure (I) include: 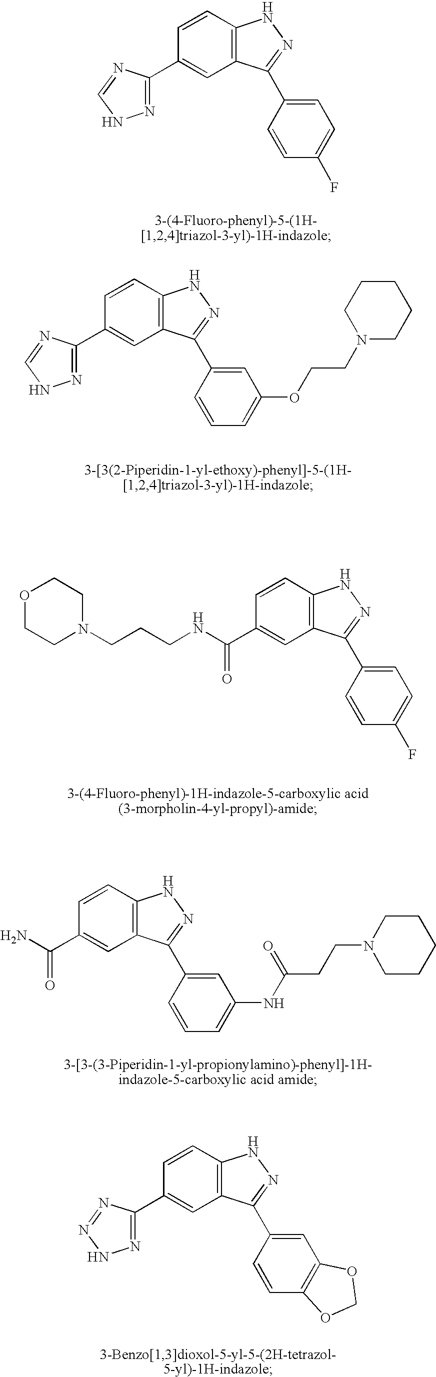 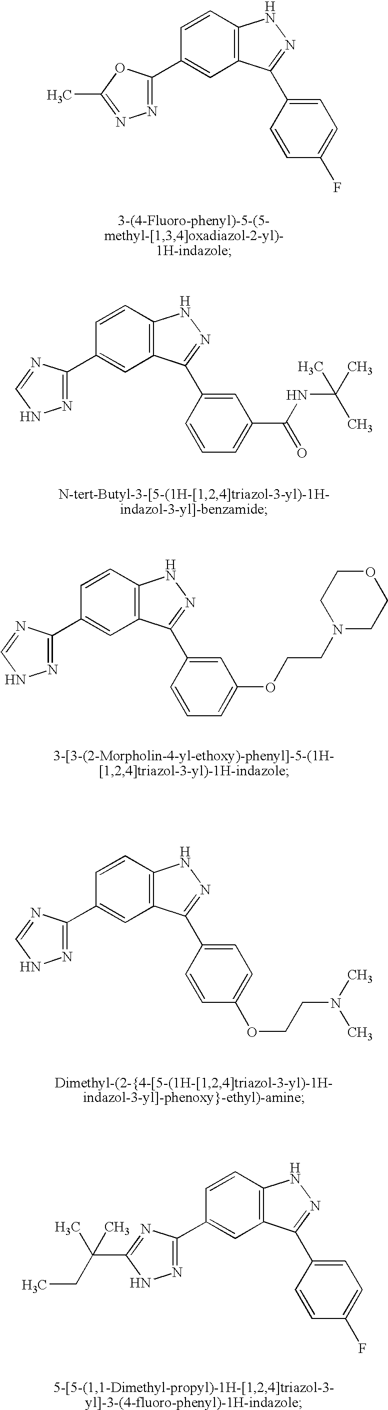 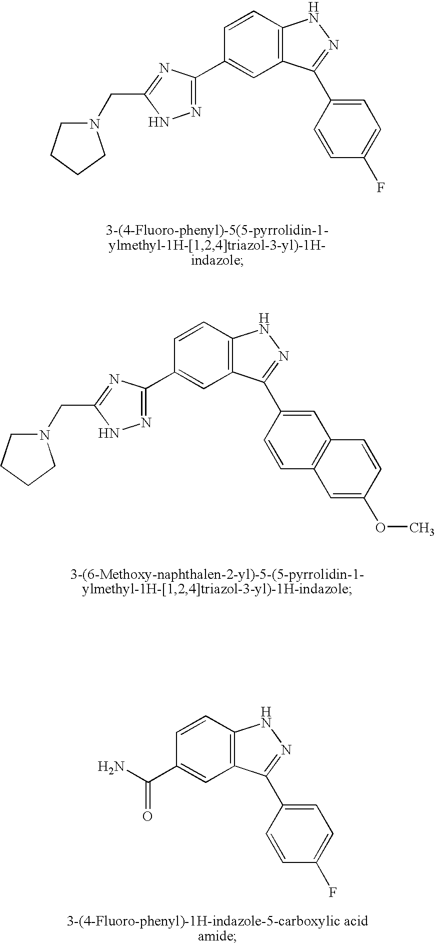
and pharmaceutically acceptable salts thereof.

In another embodiment, the JNK Inhibitor has the following structure (II): 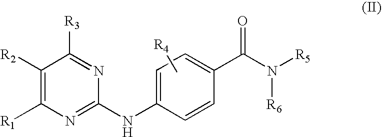
including stereoisomers, clathrates, solvates, prodrugs, polymorphs or pharmaceutically acceptable salts thereof,
wherein:
R₁ is aryl or heteroaryl optionally substituted with one to four substituents independently selected from R₇;
R₂ is hydrogen;
R₃ is hydrogen or lower alkyl;
R₄ represents one to four optional substituents, wherein each substituent is the same or different and independently selected from halogen, hydroxy, lower alkyl and lower alkoxy;
R₅ and R₆ are the same or different and independently —R₈, —(CH₂)ₐC(═O)R₉, —(CH₂)ₐC(═O)OR₉, —(CH₂)ₐC(═O)NR₉R₁₀, —(CH₂)ₐC(═O)NR₉(CH₂)_{b}C(═O)R₁₀, —(CH₂)ₐNR₉C(═O)R₁₀, (CH₂)ₐNR₁₁C(═O)NR₉R₁₀, —(CH₂)ₐNR₉R₁₀, —(CH₂)ₐOR₉, —(CH₂)ₐSO_{c}R₉ or —(CH₂)ₐSO₂NR₉R₁₀;
or R₅ and R₆ taken together with the nitrogen atom to which they are attached to form a heterocycle or substituted heterocycle;
R₇ is at each occurrence independently halogen, hydroxy, cyano, nitro, carboxy, alkyl, alkoxy, haloalkyl, acyloxy, thioalkyl, sulfinylalkyl, sulfonylalkyl, hydroxyalkyl, aryl, arylalkyl, heterocycle, substituted heterocycle, heterocycloalkyl, —C(═O)OR₈, —OC(═O)R₈, —C(═O)NR₈R₉, —C(═O)NR₈OR₉, —SO_{c}R₈, —SO_{c}NR₈R₉, —NR₈SO_{c}R₉, —NR₈R₉, —NR₈C(═O)R₉, —NR₈C(═O)(CH₂)_{b}OR₉, —NR₈C(═O)(CH₂)_{b}R₉, —O(CH₂)_{b}NR₈R₉, or heterocycle fused to phenyl;
R₈, R₉, R₁₀ and R₁₁ are the same or different and at each occurrence independently hydrogen, alkyl, aryl, arylalkyl, heterocycle, heterocycloalkyl;
or R₈ and R₉ taken together with the atom or atoms to which they are attached to form a heterocycle;
a and b are the same or different and at each occurrence independently selected from 0, 1, 2, 3 or 4; and
c is at each occurrence 0, 1 or 2.

In one embodiment, R₁ is a substituted or unsubstituted aryl or heteroaryl. When R₁ is substituted, it is substituted with one or more substituents defined below. In one embodiment, when substituted, R₁ is substituted with a halogen, —SO₂R₈ or —SO₂R₈R₉.

In another embodiment, R₁ is substituted or unsubstituted aryl, furyl, benzofuranyl, thiophenyl, benzothiophenyl, quinolinyl, pyrrolyl, indolyl, oxazolyl, benzoxazolyl, imidazolyl, benzimidazolyl, thiazolyl, benzothiazolyl, isoxazolyl, pyrazolyl, isothiazolyl, pyridazinyl, pyrimidinyl, pyrazinyl, triazinyl, cinnolinyl, phthalazinyl or quinazolinyl.

In another embodiment R₁ is substituted or unsubstituted aryl or heteroaryl. When R₁ is substituted, it is substituted with one or more substituents defined below. In one embodiment, when substituted, R₁ is substituted with a halogen, —SO₂R₈ or —SO₂R₈R₉.

In another embodiment, R₁ is substituted or unsubstituted aryl, preferably phenyl. When R₁ is a substituted aryl, the substituents are defined below. In one embodiment, when substituted, R₁ is substituted with a halogen, —SO₂R₈ or —SO₂R₈R₉.

In another embodiment, R₅ and R₆, taken together with the nitrogen atom to which they are attached form a substituted or unsubstituted nitrogen-containing non-aromatic heterocycle, in one embodiment, piperazinyl, piperidinyl or morpholinyl.

When R₅ and R₆, taken together with the nitrogen atom to which they are attached form substituted piperazinyl, piperadinyl or morpholinyl, the piperazinyl, piperadinyl or morpholinyl is substituted with one or more substituents defined below. In one embodiment, when substituted, the substituent is alkyl, amino, alkylamino, alkoxyalkyl, acyl, pyrrolidinyl or piperidinyl.

In one embodiment, R₃ is hydrogen and R₄ is not present, and the JNK Inibitor has the following structure (IIA): 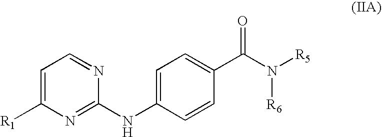
and pharmaceutically acceptable salts thereof.

In a more specific embodiment, R₁ is phenyl optionally substituted with R₇, and having the following structure (IIB): 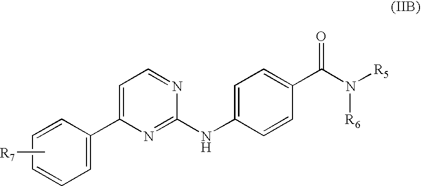
and pharmaceutically acceptable salts thereof.

In still a further embodiment, R₇ is at the para position of the phenyl group relative to the pyrimidine, as represented by the following structure (IIC): 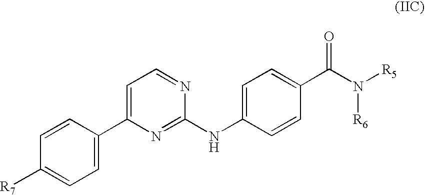
and pharmaceutically acceptable salts thereof.

The JNK Inhibitors of structure (II) can be made using organic synthesis techniques known to those skilled in the art, as well as by the methods described in International Publication No. WO 02/46170 (particularly Examples 1-27 at page 23, line 5 to page 183, line 25), published Jun. 13, 2002, which is hereby incorporated by reference in its entirety. Further, specific examples of these compounds are found in the publication.

Illustrative examples of JNK Inhibitors of structure (II) are: 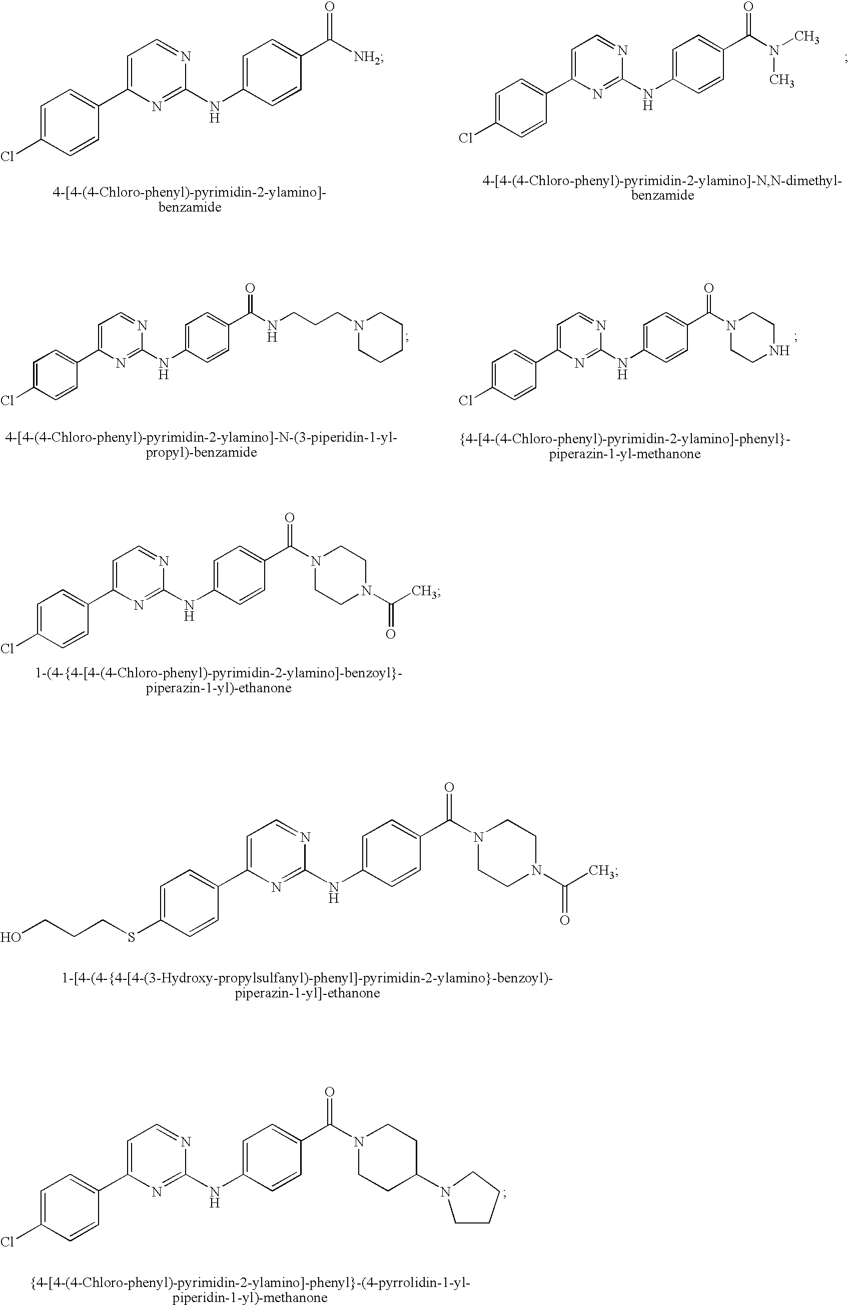
and pharmaceutically acceptable salts thereof.

In another embodiment, the JNK Inhibitor has the following structure (III): 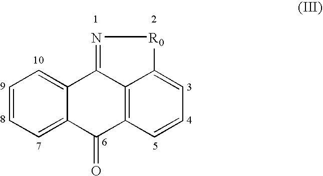
including stereoisomers, clathrates, solvates, prodrugs, polymorphs or pharmaceutically acceptable salts thereof,
wherein R₀ is —O—, —S—, —S(O)—, —S(O)₂—, NH or —CH₂—;
the compound of structure (III) being: (i) unsubstituted, (ii) monosubstituted and having a first substituent, or (iii) disubstituted and having a first substituent and a second substituent;
the first or second substituent, when present, is at the 3, 4, 5, 7, 8, 9, or 10 position, wherein the first and second substituent, when present, are independently alkyl, hydroxy, halogen, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 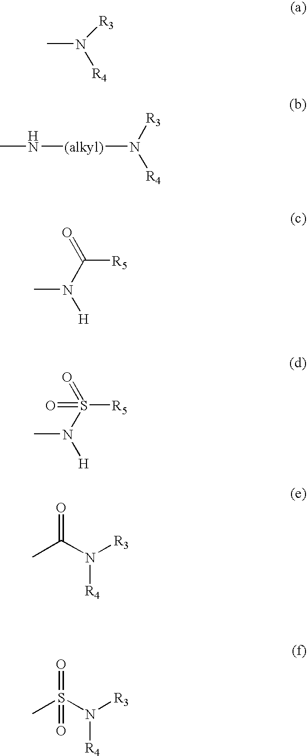
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

In another embodiment, the JNK Inhibitor has the following structure (IIIA): 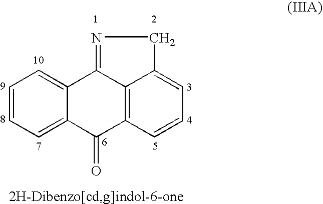
being: (i) unsubstituted, (ii) monosubstituted and having a first substituent, or (iii) disubstituted and having a first substituent and a second substituent; the first or second substituent, when present, is at the 3, 4, 5, 7, 8, 9, or 10 position;
wherein the first and second substituent, when present, are independently alkyl, hydroxy, halogen, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 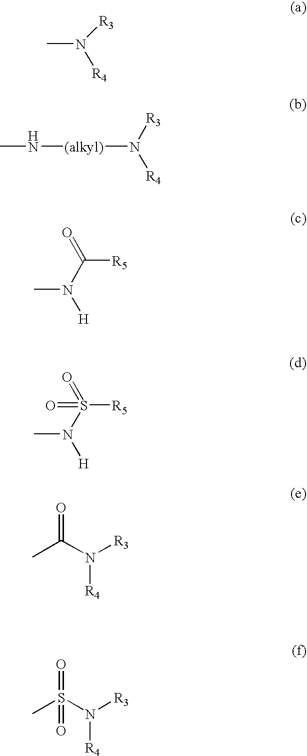
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

A subclass of the compounds of structure (IIIA) is that wherein the first or second substituent is present at the 5, 7, or 9 position. In one embodiment, the first or second substituent is present at the 5 or 7 position.

A second subclass of compounds of structure (IIIA) is that wherein the first or second substituent is present at the 5, 7, or 9 position;
the first or second substituent is independently alkoxy, aryloxy, aminoalkyl, mono-alkylaminoalkyl, di-alkylaminoalkyl, or a group represented by the structure (a), (c), (d), (e), or (f);
R₃ and R₄ are independently hydrogen, alkyl, cycloalkyl, aryl, arylalkyl, or cycloalkylalkyl; and
R₅ is hydrogen, alkyl, cycloalkyl, aryl, arylalkyl, or cycloalkylalkyl.

In another embodiment, the JNK Inhibitor has the following structure (IIIB): 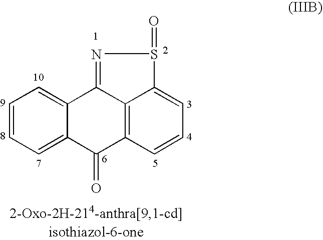
being (i) unsubstituted, (ii) monosubstituted and having a first substituent, or (ii) disubstituted and having a first substituent and a second substituent;
the first or second substituent, when present, is at the 3, 4, 5, 7, 8, 9, or 10 position;
wherein the first and second substituent, when present, are independently alkyl, halogen, hydroxy, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b) (c), (d), (e), or (f): 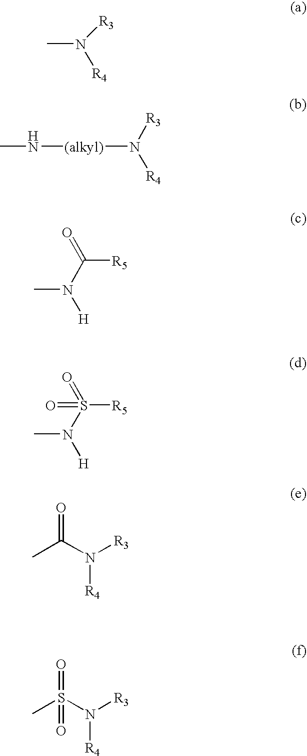
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

A subclass of the compounds of structure (IIIB) is that wherein the first or second substituent is present at the 5, 7, or 9 position. In one embodiment, the first or second substituent is present at the 5 or 7 position.

A second subclass of the compounds of structure (IIIB) is that wherein the first or second substituent is independently alkoxy, aryloxy, or a group represented by the structure (a), (c), (d), (e), or (f);
R₃ and R⁴ are independently hydrogen, alkyl, cycloalkyl, aryl, arylalkyl, or cycloalkylalkyl; and
R₅ is hydrogen, alkyl, cycloalkyl, aryl, arylalkyl, or cycloalkylalkyl.

In another embodiment, the JNK Inhibitor has the following structure (IIIC): 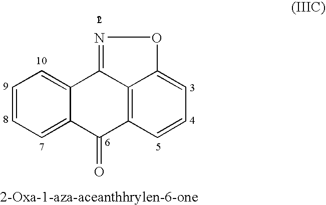
being (i) monosubstituted and having a first substituent or (ii) disubstituted and having a first substituent and a second substituent;
the first or second substituent, when present, is at the 3, 4, 5, 7, 8, 9, or 10 position;
wherein the first and second substituent, when present, are independently alkyl, halogen, hydroxy, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c) (d), (e), or (f): 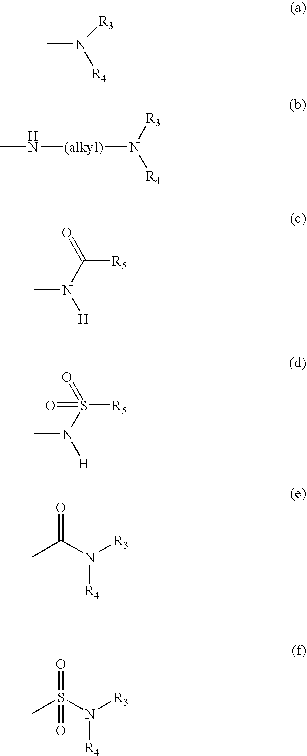
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

A subclass of the compounds of structure (IIIC) is that wherein the first or second substituent is present at the 5, 7, or 9 position. In one embodiment, the first or second substituent is present at the 5 or 7 position.

A second subclass of the compounds of structure (IIIC) is that wherein the first or second substituent is independently alkoxy, aryloxy, aminoalkyl, mono-alkylaminoalkyl, di-alkylaminoalkyl, or a group represented by the structure (a), (c), (d), (e), or (f);
R₃ and R₄ are independently hydrogen, alkyl, cycloalkyl, aryl, arylalkyl, or cycloalkylalkyl; and
R₅ is hydrogen, alkyl, cycloalkyl, aryl, arylalkyl, or cycloalkylalkyl.

In another embodiment, the JNK Inhibitor has the following structure (IIID): 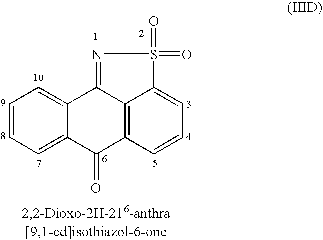
being (i) monosubstituted and having a first substituent present at the 5, 7, or 9 position, (ii) disubstituted and having a first substituent present at the 5 position and a second substituent present at the 7 position, (iii) disubstituted and having a first substituent present at the 5 position and a second substituent present at the 9 position, or (iv) disubstituted and having a first substituent present at the 7 position and a second substituent present at the 9 position;
wherein the first and second substituent, when present, are independently alkyl, halogen, hydroxy, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 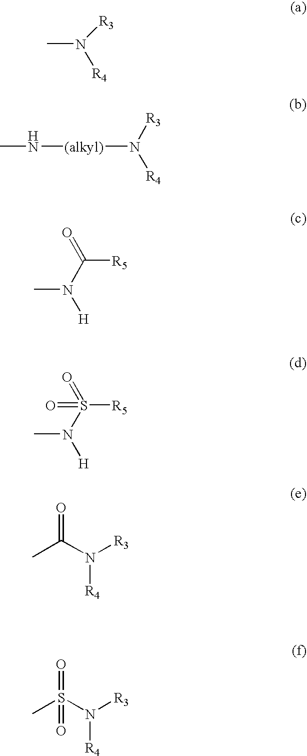
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

A subclass of the compounds of structure (IIID) is that wherein the first or second substituent is present at the 5 or 7 position.

A second subclass of the compounds of structure (IIID) is that wherein the first or second substituent is independently alkyl, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (c), (d), (e), or (f).

Another subclass of the compounds of structure (IIID) is that wherein the first and second substituent are independently alkoxy, aryloxy, or a group represented by the structure (a), (c), (d), (e), or (f);
R₃ and R₄ are independently hydrogen, alkyl, cycloalkyl, aryl, arylalkyl, or cycloalkylalkyl; and
R₅ is hydrogen, alkyl, cycloalkyl, aryl, arylalkyl, alkoxycarbonyl, or cycloalkylalkyl.

In another embodiment, the JNK Inhibitor has the following structure (IIIE): 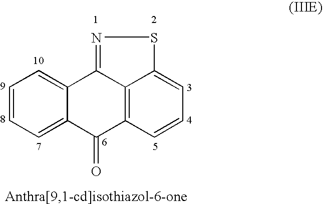
being (i) monosubstituted and having a first substituent present at the 5, 7, or 9 position, (ii) disubstituted and having a first substituent present at the 5 position and a second substituent present at the 9 position, (iii) disubstituted and having a first substituent present at the 7 position and a second substituent present at the 9 position, or (iv) disubstituted and having a first substituent present at the 5 position and a second substituent present at the 7 position;
wherein the first and second substituent, when present, are independently alkyl, halogen, hydroxy, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 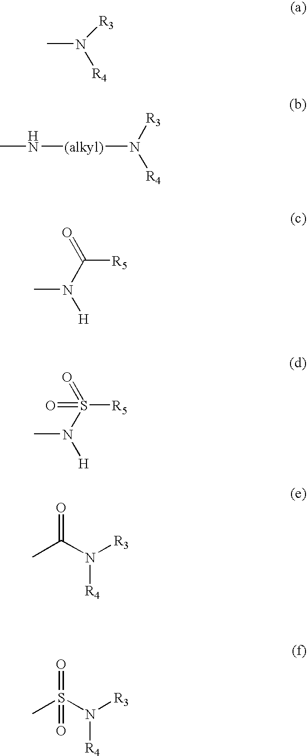
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

A subclass of the compounds of structure (IIE) is that wherein the first or second substituent is present at the 5 or 7 position.

A second subclass of the compounds of structure (IIE) is that wherein the compound of structure (IIE) is disubstituted and at least one of the substituents is a group represented by the structure (d) or (f).

Another subclass of the compounds of structure (IIE) is that wherein the compounds are monosubstituted. Yet another subclass of compounds is that wherein the compounds are monosubstituted at the 5 or 7 position with a group represented by the structure (e) or (f).

In another embodiment, the JNK Inhibitor has the following structure (IIIF): 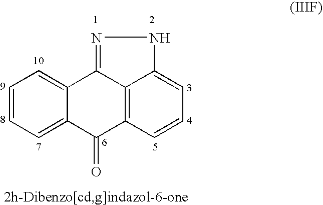
being (i) unsubstituted, (ii) monosubstituted and having a first substituent, or (iii) disubstituted and having a first substituent and a second substituent;
the first or second substituent, when present, is at the 3, 4, 5, 7, 8, 9, or 10 position;
wherein the first and second substituent, when present, are independently alkyl, hydroxy, halogen, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 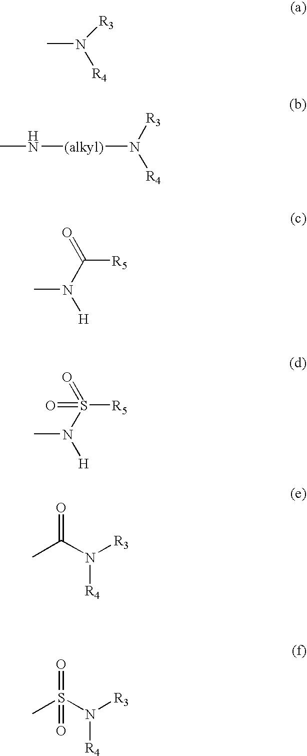
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

In one embodiment, the compound of structure (IIIF), or a pharmaceutically acceptable salt thereof is unsubstituted at the 3, 4, 5, 7, 8, 9, or 10 position.

The JNK Inhibitors of structure (III) can be made using organic synthesis techniques known to those skilled in the art, as well as by the methods described in International Publication No. WO 01/12609 (particularly Examples 1-7 at page 24, line 6 to page 49, line 16), published Feb. 22, 2001, as well as International Publication No. WO 02/066450 (particularly compounds AA-HG at pages 59-108), published Aug. 29, 2002, each of which is hereby incorporated by reference in its entirety. Further, specific examples of these compounds can be found in the publications.

Illustrative examples of JNK Inhibitors of structure (III) are: 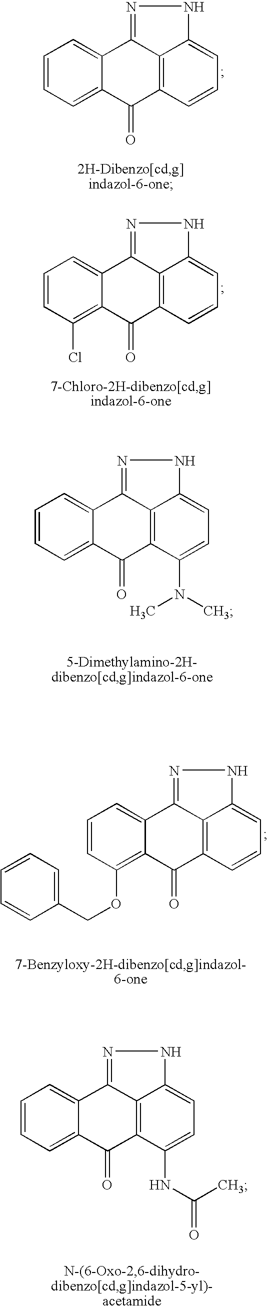 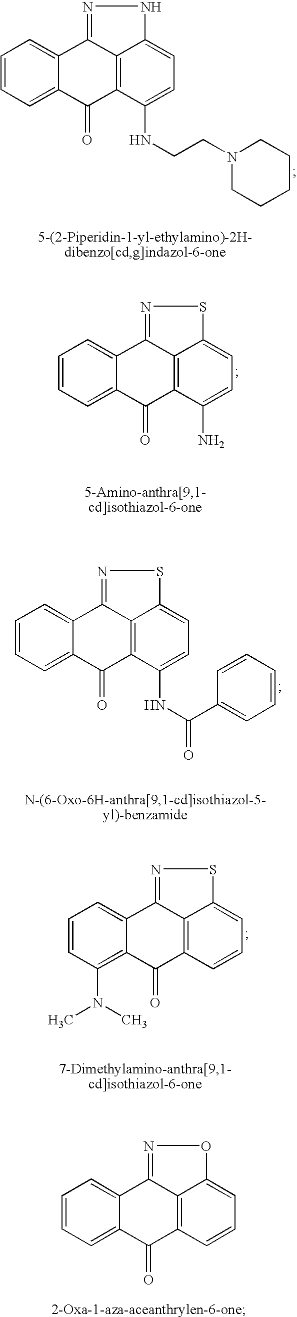
and pharmaceutically acceptable salts thereof.

Other JNK Inhibitors that are useful in the present methods include, but are not limited to, those disclosed in International Publication No. WO 00/39101, (particularly at page 2, line 10 to page 6, line 12); International Publication No. WO 01/14375 (particularly at page 2, line 4 to page 4, line 4); International Publication No. WO 00/56738 (particularly at page 3, line 25 to page 6, line 13); International Publication No. WO 01/27089 (particularly at page 3, line 7 to page 5, line 29); International Publication No. WO 00/12468 (particularly at page 2, line 10 to page 4, line 14); European Patent Publication 1 110 957 (particularly at page 19, line 52 to page 21, line 9); International Publication No. WO 00/75118 (particularly at page 8, line 10 to page 11, line 26); International Publication No. WO 01/12621 (particularly at page 8, line 10 to page 10, line 7); International Publication No. WO 00/64872 (particularly at page 9, line 1 to page, 106, line 2); International Publication No. WO 01/23378 (particularly at page 90, line 1 to page 91, line 11); International Publication No. WO 02/16359 (particularly at page 163, line 1 to page 164, line 25); U.S. Pat. No. 6,288,089 (particularly at column 22, line 25 to column 25, line 35); U.S. Pat. No. 6,307,056 (particularly at column 63, line 29 to column 66, line 12); International Publication No. WO 00/35921 (particularly at page 23, line 5 to page 26, line 14); International Publication No. WO 01/91749 (particularly at page 29, lines 1-22); International Publication No. WO 01/56993 (particularly in at page 43 to page 45); and International Publication No. WO 01/58448 (particularly in at page 39), each of which is incorporated by reference herein in its entirety.

4.2 Methods of Use

Without being limited by theory, tissue preservation agents and techniques are thought to be effective at least in part due to manipulation of temperature and the use of agents that counteract osmotic flux. A JNK Inhibitor is useful as a tissue preservation agent in settings of both cold and warm ischemia, and is also useful in combination with known organ preservation solutions and agents. Accordingly, each of the embodiments described herein can be associated with a setting of cold or warm ischemia and can further comprise a known organ preservation solution or agent including, but not limited to, those described herein.

In one embodiment, the invention relates to methods for preserving tissue, comprising contacting ex vivo tissue with an effective amount of a JNK Inhibitor. The term “contacting” includes coating, permeating, pouring, immersing, perfusing, infusing or diffusing a solution comprising a JNK Inhibitor over or through a tissue resulting in an effective amount of the JNK Inhibitor coming into contact with the tissue. In one embodiment, the contacting is for a period of time sufficient to preserve tissue, prevent reperfusion injury to implanted tissue, prevent transplant rejection or preserve a cell to be implanted. In another embodiment, the tissue is contacted with a composition comprising an effective amount of a JNK Inhibitor and a pharmaceutically acceptable carrier.

Without being limited by theory, it is thought that an inhibitor of JNK is particularly useful for treating, preventing or reducing ischemia-reperfusion injury because it is believed that JNK is activated within about one minute of a reperfusion event.

In another embodiment, the invention relates to a method for preventing ischemia-reperfusion injury that occurs during or as a result of surgery or trauma from accident comprising administering an effective amount of a JNK Inhibitor to a patient in need thereof. Particular types of surgery include, but are not limited to, coronary artery bypass surgery, percutaneous transluminal coronary angioplasty, orthopedic surgery (e.g., that requiring the use of a tourniquet), organ/vessel surgery (e.g., plaque or tumor removal that may require temporal clamping of a blood vessel), organ/tissue transplant or skin graft. Particular types of trauma from accident include, but are not limited to, vehicle accident, gunshot wound and limb crush.

In another embodiment, the invention relates to a method for reducing damage to heart tissue and preventing cognitive dysfunction within about six months after surgery comprising administering an effective amount of a JNK Inhibitor to a patient in need thereof. In one embodiment, the damage to heart tissue is caused by creatine kinase, aspartate transaminase or lactate dehydrogenase.

In another embodiment, the invention relates to a method for improving muscoskeletal function after surgery comprising administering an effective amount of a JNK Inhibitor to a patient in need thereof.

In another embodiment, the invention relates to a method for improving organ function (e.g., liver or kidney) after transplant comprising contacting an organ (e.g., administering to a patient in need thereof) with an effective amount of a JNK Inhibitor.

In another embodiment, the invention relates to a method for expanding the pool of organs suitable for transplant comprising contacting a marginal organ (e.g., liver or kidney) with an effective amount of a JNK Inhibitor. In one embodiment, a marginal organ is an organ with a risk of initial poor function or primary non-function.

In another embodiment, the invention relates to methods for preventing reperfusion injury to implanted tissue, comprising: (a) contacting tissue with an effective amount of a JNK Inhibitor; and (b) implanting the contacted tissue in a recipient. In one embodiment, the tissue is contacted in vivo. In another embodiment, the tissue is contacted ex vivo. In one embodiment, the tissue is contacted with a composition comprising an effective amount of a JNK Inhibitor and a pharmaceutically acceptable carrier.

In another embodiment, the invention relates to methods for preventing transplant rejection, comprising: (a) administering to a transplant recipient in need thereof an effective amount of a JNK Inhibitor; and (b) transplanting tissue in a recipient. In another embodiment, the recipient is administered a composition comprising an effective amount of a JNK Inhibitor and a pharmaceutically acceptable carrier.

In another embodiment, the invention relates to methods for preserving tissue, comprising: (a) administering an effective amount of a JNK Inhibitor to a tissue donor; and (b) removing the tissue from the donor. In another embodiment, the methods further comprise: (c) implanting the tissue in a recipient. In another embodiment, the donor or recipient is administered a composition comprising an effective amount of a JNK Inhibitor and a pharmaceutically acceptable carrier.

In another embodiment, the invention relates to methods for preserving an organ, comprising: (a) administering an effective amount of a JNK Inhibitor to an organ donor; and (b) removing the organ from the donor. In another embodiment, the methods further comprise: (c) implanting the organ in a recipient. In another embodiment, the donor or recipient is administered a composition comprising an effective amount of a JNK Inhibitor and a pharmaceutically acceptable carrier.

In another embodiment, the invention relates to methods for preserving a cell to be implanted, comprising: (a) contacting a cell with an effective amount of a JNK Inhibitor; and (b) implanting the contacted cell in a recipient. In one embodiment, the cell is contacted with a composition comprising an effective amount of the JNK Inhibitor and a pharmaceutically acceptable carrier.

Representative tissues that are useful for the methods of the present invention include human or human compatible (e.g., non-human mammalian) tissues, such as heart valve, bone, skin, cornea, vein, cartilage and tendon. In other embodiments, the tissue can be an organ, biological fluid or cell. Representative organs that are suitable for the methods of the present invention include human or human compatible (e.g., non-human mammalian) organs, such as heart, intestine, kidney, liver, lung and pancreas. Representative biological fluids that are suitable for the methods of the present invention include, but are not limited to, blood or plasma. Representative cells that are useful for the methods of the present invention include those of the tissues, organs or biological fluids, above, as well as pancreas islet cells and stem cells.

In one embodiment, the methods for preserving tissue further comprise cryopreserving the tissue (e.g., freezing in liquid nitrogen, freezing with dry ice, freezing with ice water, freezing with a cold-pack or storing in a refrigerator or freezer). The cryopreserving can be performed prior or subsequent to contacting a cell or tissue with an effective amount of a JNK Inhibitor. In a particular embodiment, the cryopreserving of the tissue is performed while the JNK Inhibitor is exerting its effect on the tissue.

In one embodiment, the tissue is preserved for subsequent implantation. In one embodiment, the implantation is transplantation. In another embodiment, the tissue is preserved for another use including, but not limited to, autopsy, forensic analysis or academic study.

In one embodiment, the methods further comprise contacting ex vivo tissue, for example tissue to be transplanted, with an effective amount of an immunosuppressant. Suitable immunosuppressant include, but are not limited to, cyclosporine, tacrolimus, pimecrolimus, azathioprine, sirolimus, mycophenolate mofetil or infliximab. In another embodiment, the invention further comprises administering an effective amount of an immunosuppressant to a transplant recipient before, during or after the transplant, or to a tissue donor before or during the transplant. In these embodiments, the immunosuppressant exerts its activity while the JNK Inhibitor exerts its activity.

In one embodiment, the invention further comprises contacting ex vivo tissue, for example, tissue to be implanted, with an effective amount of an antibiotic. In certain embodiments, the antibiotic is a macrolide (e.g., tobramycin), a cephalosporin (e.g., cephalexin, cephradine, cefuroxime, cefprozil, cefaclor, cefixime or cefadroxil), a clarithromycin, an erythromycin, a penicillin (e.g., penicillin V) or a quinolone (e.g., ofloxacin, ciprofloxacin or norfloxacin). In a particular embodiment, the antibiotic is active against Pseudomonas aeruginosa. In one embodiment, the JNK Inhibitor can be administered or formulated in combination with an antibiotic.

In one embodiment, a cell or tissue useful in the methods of the present invention is kept in a functioning state during the preservation period, e.g., prior to implantation. Devices that are useful in this regard include, but are not limited to, a perfusion apparatus (e.g., U.S. Pat. Nos. 6,046,046 and 6,100,082 to Hassanein, each being incorporated by reference herein in its entirety) and an artificial circulatory apparatus (e.g., U.S. Pat. No. 5,752,929 to Klatz, incorporated by reference herein in its entirety).

In another embodiment, the invention relates to a method for treating or preventing acetaminophen poisoning causing liver failure, acute alcohol-induced liver injury, stroke, myocardial infarction or angina comprising administering an effective amount of a JNK Inhibitor to a patient in need thereof.

In another embodiment, the invention relates to the prevention of organ or tissue injury comprising the administration of an effective amount of a JNK Inhibitor to a patient during renal dialysis, peritoneal dialysis or transfusion.

In another embodiment, a JNK Inhibitor is administered in combination with (e.g., simultaneously or sequentially) another active agent useful for treating or preventing ischemia-reperfusion injury or preserving a cell, tissue or organ. In a particular embodiment, a JNK Inhibitor is administered in combination with a p38 inhibitor (e.g., VX-702). In another embodiment, a JNK Inhibitor is administered in combination with a PKC-delta inhibitor (e.g., KAI-9803).9516

4.3 Compositions

The present invention relates to compositions comprising an effective amount of a JNK Inhibitor and an ex vivo tissue (i.e., a tissue composition), compositions comprising an effective amount of a JNK Inhibitor and a carrier (i.e., a pharmaceutical composition) and compositions comprising an effective amount of a JNK Inhibitor and another tissue-preservation agent (i.e., a tissue-preservation composition).

4.3.1 Tissue Compositions

In one embodiment, the invention relates to tissue compositions comprising ex vivo tissue and an effective amount of a JNK Inhibitor. In one embodiment, the tissue composition is cryopreserved (e.g., cooled or frozen in liquid nitrogen, in dry ice, in ice water; cooled or frozen with a cold-pack; or stored in a refrigerator or freezer).

In another embodiment, the invention relates to a container containing a tissue composition. In another embodiment, the tissue composition further comprises a pharmaceutically acceptable carrier. In one embodiment, the tissue composition that is cryopreserved, above, is contained in a container.

The tissue compositions can further comprise an effective amount of another tissue-preservation agent.

Examples of other tissue-preservation agents include, but are not limited to:
1) a macromolecule of molecular weight greater than 20,000 daltons, in one embodiment, present in an amount sufficient to maintain endothelial integrity and cellular viability (e.g., a synthetic or naturally occurring colloid, a polysaccharide such as dextran or a polyethylene glycol present at about 25 μl to about 100 g/l, or about 40 g/l to about 60 g/l);
2) D-Glucose, in one embodiment, present in an amount sufficient to support intracellular function and maintain cellular bioenergetics (e.g., about 50 mM to about 80 mM);
3) magnesium ions (e.g., about 1 mM to about 20 mM);
4) potassium ions (e.g., about 110 mM to about 140 mM);
5) adenosine (e.g., about 3 mM to about 20 mM);
6) an antioxidant (e.g., butylated hydroxyanisole, butylated hydroxytoluene, glutathione, Vitamin C or Vitamin E present at about 25 μM to about 100 μM);
7) a reducing agent, in one embodiment, present in an amount sufficient to help decrease reperfusion injury (e.g., N-acetylcysteine present at about 0.1 mM to about 5 mM);
8) an agent that prevents calcium entry into cells (e.g., verapamil present at about 2 μM to about 25 μM);
9) a vasodilator, in one embodiment, a phosphodiesterase inhibitor (e.g., dibutyryl adenosine, isobutylmethylxanthine, indolidan, rolipram, 2-o-propoxyphenyl-8-azapurin-6-one, trequensin, amrinone, milrinon, aminophylline or dipyridamole);
10) nitroglycerin (e.g., about 0.05 μl to about 0.2 μl);
11) an anticoagulant, in one embodiment, present in an amount sufficient to help prevent clotting of blood (e.g., heparin or hirudin present at a concentration of about 1000 units/i to about 100,000 units/l);
12) a bacteriostat (e.g., cefazolin or penicillin present at about 0.25 g/l to about 1 μl); and
13) an amiloride containing compound (e.g., amiloride, ethyl isopropyl amiloride, hexamethylene amiloride, dimethyl amiloride or isobutyl amiloride present at about 1.0 μM to about 5 μM).

In another embodiment, the tissue-preservation agent is the Stanford University solution (Swanson et al., J. of Heart Transplantation 7:456-467 (1988)).

In another embodiment, the tissue-preservation agent is a modified Collins solution (Maurer et al., Transplantation Proceedings 22:548-550 (1990)).

In another embodiment, the tissue-preservation agent is the UW solution (Belzer et al., U.S. Pat. No. 4,798,824).

In another embodiment, the tissue-preservation agent is the Columbia University solution (Stem et al., U.S. Pat. No. 5,552,267).

In another embodiment, the tissue-preservation agent is a cardoplegia solution (e.g., a solution containing an elevated level of potassium).

In one embodiment, the osmolarity of a tissue composition comprising another tissue-preservation agent is about 300 mOSm/l to about 400 mOSm/l or about 315 mOSm/l to about 340 mOSm/l.

In one embodiment the tissue composition is substantially-free (e.g., less than 1 μm, less than 1 nm or less than 1 μm) of sodium ions. In another embodiment, the tissue composition is substantially free of chloride ions (e.g., less than 1 μm, less than 1 nm or less than 1 μm). In another embodiment, the tissue composition is substantially free of calcium ions (e.g., less than 1 μm, less than 1 nm or less than 1 μm).

In one embodiment, the tissue composition further comprises a buffer, such as a phosphate buffer (e.g., KH₂PO₄) or a bicarbonate buffer (e.g., Na₂CO₃), which maintains an average pH of about physiological pH during tissue preservation. In another embodiment, the average pH of the tissue composition is between about 7.4 and about 7.6. The pH of the tissue composition can be adjusted with a suitable acid or base before or during preservation of the tissue.

In one embodiment, the tissue composition further comprises whole blood or leukocyte-depleted whole blood that is compatible with the tissue to be preserved.

4.3.2 Pharmaceutical Compositions

In one embodiment, the invention relates to pharmaceutical compositions useful in the methods of the present invention comprising an effective amount of a JNK Inhibitor and a pharmaceutically acceptable carrier. The pharmaceutical compositions can be administered to the recipient or donor. The term “carrier” refers to a diluent, adjuvant, excipient, or vehicle. Such pharmaceutical carriers can be liquids, such as water and oils, including those of petroleum, animal, vegetable or synthetic origin, such as peanut oil, soybean oil, mineral oil, sesame oil and the like. The pharmaceutical carrier can be saline, gum acacia, gelatin, starch paste, talc, keratin, colloidal silica, urea, and the like. In addition, auxiliary, stabilizing, thickening, lubricating and coloring agents may be used.

Pharmaceutical compositions can be substantially anhydrous (e.g., comprising less than 1% water) pharmaceutical compositions since water can facilitate the degradation of some compounds. For example, the addition of water (e.g., 5%) is widely accepted in the pharmaceutical arts as a means for determining shelf-life or the stability of formulations over time. See, e.g., Jens T. Carstensen, Drug Stability: Principles & Practice, 2d. Ed., Marcel Dekker, NY, N.Y., 1995, pp. 379-80.

A substantially anhydrous pharmaceutical composition can be prepared and stored such that its substantially anhydrous nature is maintained. Accordingly, substantially anhydrous compositions can be packaged using materials known to prevent exposure to water such that they can be included in suitable formulary kits. Examples of suitable packaging include, but are not limited to, hermetically sealed foils, plastics, unit dose containers (e.g., vials), blister packs, and strip packs.

The invention further encompasses pharmaceutical compositions that comprise one or more agents that reduce the rate by which an active ingredient will decompose. Such agents, which are referred to herein as “stabilizers,” include, but are not limited to, antioxidants such as ascorbic acid, pH buffers, or salt buffers.

The pharmaceutical compositions can be administered to recipients or donors by various routes including, but not limited to, infusion, subcutaneous, intravenous (including bolus injection), intramuscular, and intra-arterial. Pharmaceutical compositions to be infused can be solutions ready for injection, dry products ready to be dissolved or suspended in a pharmaceutically acceptable carrier for injection, suspensions ready for injection, and emulsions. For example, lyophilized sterile pharmaceutical compositions suitable for reconstitution into particulate-free dosage forms suitable for administration to humans.

In one embodiment, the point of injection for infusion is a major blood or lymph vessel. In another embodiment, the point of injection for infusion is the tissue to be preserved.

Pharmaceutical compositions of the invention that are suitable for oral administration can be presented as discrete dosage forms, such as, but not limited to, tablets (e.g., chewable tablets), caplets, capsules, and liquids (e.g., flavored syrups). Such dosage forms contain a predetermined amount of a JNK Inhibitor, and may be prepared by methods of pharmacy well known to those skilled in the art. See generally, Remington's Pharmaceutical Sciences, 18^{th ed., Mack Publishing, Easton Pa. (}1990).

Typical pharmaceutical compositions useful for oral administration to a recipient can be prepared by combining the JNK Inhibitor with at least one carrier according to conventional pharmaceutical compounding techniques. Carriers can take a wide variety of forms depending on the form of pharmaceutical composition desired for administration. For example, carriers suitable for use in oral liquid or aerosol pharmaceutical compositions include, but are not limited to, water, glycols, oils, alcohols, flavoring agents, preservatives, and coloring agents. Examples of carriers suitable for use in solid pharmaceutical compositions (e.g., powders, tablets, capsules, and caplets) include, but are not limited to, starches, sugars, micro-crystalline cellulose, diluents, granulating agents, lubricants, binders, and disintegrating agents.

Because of their ease of oral administration, tablets and capsules represent the most advantageous pharmaceutical compositions unit forms, in which case solid carriers are employed. If desired, tablets can be coated by standard aqueous or nonaqueous techniques. Such pharmaceutical compositions can be prepared by any of the methods of pharmacy. In general, pharmaceutical compositions are prepared by uniformly and intimately admixing the JNK Inhibitor with liquid carriers, finely divided solid carriers, or both, and then shaping the product into the desired presentation if necessary.

Examples of carriers that can be used in pharmaceutical compositions for oral administration include, but are not limited to, corn starch, potato starch, or other starches, gelatin, natural and synthetic gums such as acacia, sodium alginate, alginic acid, other alginates, powdered tragacanth, guar gum, cellulose and its derivatives (e.g., ethyl cellulose, cellulose acetate, carboxymethyl cellulose calcium, sodium carboxymethyl cellulose), polyvinyl pyrrolidone, methyl cellulose, pre-gelatinized starch, hydroxypropyl methyl cellulose, (e.g., Nos. 2208, 2906, 2910), microcrystalline cellulose, talc, calcium carbonate (e.g., granules or powder), microcrystalline cellulose, powdered cellulose, dextrates, kaolin, mannitol, silicic acid, sorbitol, starch, pre-gelatinized starch, and mixtures thereof. The carrier in a pharmaceutical composition is typically present in from about 50 to about 99 weight percent of the pharmaceutical composition.

Suitable forms of microcrystalline cellulose include, but are not limited to, the materials sold as AVICEL-PH-101, AVICEL-PH-103 AVICEL RC-581, AVICEL-PH-105 (available from FMC Corporation, American Viscose Division, Avicel Sales, Marcus Hook, Pa.), and mixtures thereof. An specific carrier is a mixture of microcrystalline cellulose and sodium carboxymethyl cellulose sold as AVICEL RC-581. Suitable anhydrous or low moisture carriers include AVICEL-PH-103 and Starch 1500 LM.

Disintegrants can be used in the pharmaceutical compositions of the invention to provide tablets that disintegrate when exposed to an aqueous environment. Tablets that contain too much disintegrant may disintegrate in storage, while those that contain too little may not disintegrate at a desired rate or under the desired conditions. Thus, a sufficient amount of disintegrant that is neither too much nor too little to detrimentally alter the release of the active ingredients should be used to form pharmaceutical compositions for oral administration. The amount of disintegrant used varies based upon the type of pharmaceutical composition, and is readily discernible to those skilled in the art. Typical pharmaceutical compositions comprise from about 0.5 to about 15 weight percent of disintegrant, specifically from about 1 to about 5 weight percent of disintegrant.

Disintegrants that can be used in pharmaceutical compositions of the invention include, but are not limited to, agar-agar, alginic acid, calcium carbonate, microcrystalline cellulose, croscarmellose sodium, crospovidone, polacrilin potassium, sodium starch glycolate, potato or tapioca starch, pre-gelatinized starch, other starches, clays, other algins, other celluloses, gums, and mixtures thereof.

Lubricants that can be used the pharmaceutical compositions include, but are not limited to, calcium stearate, magnesium stearate, mineral oil, light mineral oil, glycerin, sorbitol, mannitol, polyethylene glycol, other glycols, stearic acid, sodium lauryl sulfate, talc, hydrogenated vegetable oil (e.g., peanut oil, cottonseed oil, sunflower oil, sesame oil, olive oil, corn oil, and soybean oil), zinc stearate, ethyl oleate, ethyl laureate, agar, and mixtures thereof. Additional lubricants include, for example, a syloid silica gel (AEROSIL 200, manufactured by W. R. Grace Co. of Baltimore, Md.), a coagulated aerosol of synthetic silica (marketed by Degussa Co. of Plano, Tex.), CAB-O-SIL (a pyrogenic silicon dioxide product sold by Cabot Co. of Boston, Mass.), and mixtures thereof. If used at all, lubricants are typically used in an amount of less than about 1 weight percent of the pharmaceutical composition into which they are incorporated.

Pharmaceutical compositions can be administered to the donor or recipient by controlled-release means or by delivery devices that are well known to those skilled in the art. Examples include, but are not limited to, those described in U.S. Pat. Nos. 3,845,770; 3,916,899; 3,536,809; 3,598,123; and 4,008,719, 5,674,533, 5,059,595, 5,591,767, 5,120,548, 5,073,543, 5,639,476, 5,354,556, and 5,733,566, each of which is incorporated herein by reference.

Pharmaceutical compositions can be prepared to provide slow or controlled-release of one or more active ingredients using, for example, hydropropylmethyl cellulose, other polymer matrices, gels, permeable membranes, osmotic systems, multilayer coatings, microparticles, liposomes, microspheres, or a combination thereof to provide the desired release profile in varying proportions. Suitable controlled-release formulations known to those skilled in the art, including those described herein, can be readily selected for use with the pharmaceutical compositions.

Controlled-release formulations can be designed to initially release an amount of JNK Inhibitor that promptly produces the desired effect, and gradually and continually release amounts of JNK Inhibitor to maintain the effect over an extended period of time. Controlled-release of JNK Inhibitor can be stimulated by various conditions including, but not limited to, pH, temperature, enzymes, water, or other physiological conditions.

A JNK Inhibitor can also be administered directly to the lung by inhalation (See, e.g., Tong et al., PCT Application, WO 97/39745; Clark et al., PCT Application, WO 99/47196, which are herein incorporated by reference herein in their entirety). For administration by inhalation, a JNK Inhibitor can be conveniently delivered to the lung by a number of different devices. For example, a Metered Dose Inhaler (“MDI”) which utilizes canisters that contain a suitable low boiling propellant, e.g., dichlorodifluoromethane, trichlorofluoromethane, dichlorotetrafluoroethane, carbon dioxide or other suitable gas can be used to deliver a JNK Inhibitor directly to the lung. MDI devices are available from a number of suppliers such as 3M Corporation, Aventis, Boehringer Ingleheim, Forest Laboratories, Glaxo-Wellcome, Schering Plough and Vectura.

In one embodiment, the JNK Inhibitor is administered as an intravenous formulation, such as a liquid formulation or a lyophilized powder amenable for rapid dissolution and intravenous dosing. In a particular embodiment, the dosage is a bolus dosage capable of providing an initial dose of a JNK Inhibitor immediately prior to surgery. In another embodiment, the dosage is an intravenous dosage capable of maintaining a steady state concentration of a JNK Inhibitor during surgery and immediately after surgery if necessary.

In one embodiment, the dosage is capable of being administered with another infusion agent including, but not limited to, saline, glucose, an anesthetic or heparin.

The amount of a JNK Inhibitor to be administered to a recipient or donor, such as a human, is rather widely variable and can be subject to independent judgment. The JNK Inhibitor can be administered in a single dose, one or more times per day, or the JNK Inhibitor can be administered continuously (e.g., by infusion). It is often practical to administer the daily dose of a JNK Inhibitor at various hours of the day. When the JNK Inhibitor is administered to a recipient or donor, an effective amount of the JNK Inhibitor is generally about 0.001 mg/kg to about 1 g/kg, about 0.01 mg/kg to about 500 mg/kg, about 0.1 mg/kg to about 250 mg/kg, about 1 mg/kg to about 150 mg/kg, about 10 mg/kg to about 100 mg/kg or about 25 mg/kg to about 50 mg/kg. However, in any given case, the amount of a JNK Inhibitor administered will depend on such factors as the solubility of the JNK Inhibitor, the formulation used, recipient condition (such as weight), and/or the route of administration.

When the JNK Inhibitor is administered to a donor or recipient with another tissue-preservation agent, the other tissue-preservation agent can be administered in a single dose, one or more times per day, or the JNK Inhibitor can be administered continuously (e.g., by infusion). When the JNK Inhibitor is administered to a recipient or donor with another tissue-preservation agent, an effective amount of the other tissue-preservation agent is generally about 0.001 mg/kg to about 1 g/kg, about 0.01 mg/kg to about 500 mg/kg, about 0.1 mg/kg to about 250 mg/kg, about 1 mg/kg to about 150 mg/kg, about 10 mg/kg to about 100 mg/kg or about 25 mg/kg to about 50 mg/kg.

When the JNK Inhibitor is used to preserve a tissue or a cell, an effective amount of the JNK Inhibitor is generally about 1 mg/L to about 100 g/L, about 10 mg/L to about 10 g/L, about 100 mg/L to about 1 g/L or about 250 mg/L to about 500 mg/L. The tissue or cell to be preserved is generally contacted with the JNK Inhibitor for about one minute to about two weeks, for, about thirty minutes to about ten days, for about one hour to about one week, for about two hours to about three days, for about four hours to about one day, for about six hours to about twelve hours or for about eight hours to about ten hours.

5. JNK Inhibitor Activity Assays

The ability of a compound to inhibit JNK and accordingly, to be useful for preserving tissue, preventing reperfusion injury to implanted tissue, preventing transplant rejection or preserving a cell to be implanted can be demonstrated using the following procedures.

5.1 JNK2 Assay

To 10 μL of a JNK Inhibitor in 20% DMSO/80% dilution buffer consisting of 20 mM HEPES (pH 7.6), 0.1 mM EDTA, 2.5 mM magnesium chloride, 0.004% Triton×100, 2 μg/mL leupeptin, 20 mM β-glycerolphosphate, 0.1 mM sodium vanadate, and 2 mM DTT in water is added 30 μL of 50 ng His6-JNK2 in the same dilution buffer. The mixture is preincubated for 30 minutes at room temperature. Sixty microliters of 10 μg GST-c-Jun(1-79) in assay buffer consisting of 20 mM HEPES (pH 7.6), 50 mM sodium chloride, 0.1 mM EDTA, 24 mM magnesium chloride, 1 mM DTT, 25 mM PNPP, 0.05% Triton×100, 11 μM ATP, and 0.5 μCi γ-³²P ATP in water is added and the reaction is allowed to proceed for 1 hour at room temperature. The c-Jun phosphorylation is terminated by addition of 150 μL of 12.5% trichloroacetic acid. After 30 minutes, the precipitate is harvested onto a filter plate, diluted with 50 μL of the scintillation fluid and quantified by a counter. The IC₅₀ values are calculated as the concentration of the JNK Inhibitor at which the c-Jun phosphorylation is reduced to 50% of the control value. In one embodiment, the JNK Inhibitor has an IC₅₀ value ranging from 0.01-10 μM in this assay.

5.2 JNK3 Assay

To 10 μL of a JNK Inhibitor in 20% DMSO/80% dilution buffer consisting of 20 mM HEPES (pH 7.6), 0.1 mM EDTA, 2.5 mM magnesium chloride, 0.004% Triton×100, 2 μg/mL leupeptin, 20 mM β-glycerolphosphate, 0.1 mM sodium vanadate, and 2 mM DTT in water is added 30 μL of 200 ng His6-JNK3 in the same dilution buffer. The mixture is preincubated for 30 minutes at room temperature. Sixty microliter of 10 μg GST-c-Jun(1-79) in assay buffer consisting of 20 mM HEPES (pH 7.6), 50 mM sodium chloride, 0.1 mM EDTA, 24 mM magnesium chloride, 1 mM DTT, 25 mM PNPP, 0.05% Triton×100, 11 μM ATP, and 0.5 μCi γ-³²P ATP in water is added and the reaction is allowed to proceed for 1 hour at room temperature. The c-Jun phosphorylation is terminated by addition of 150 μL of 12.5% trichloroacetic acid. After 30 minutes, the precipitate is harvested onto a filter plate, diluted with 50 μL of the scintillation fluid and quantified by a counter. The IC₅₀ values are calculated as the concentration of the JNK Inhibitor at which the c-Jun phosphorylation is reduced to 50% of the control value. In one embodiment, the JNK Inhibitor has an IC₅₀ value ranging from 0.01-10 μM in this assay.

5.3 Rat Model of Total Hepatic Ischemia

Liver ischemia followed by partial hepatectomy of the noninvolved liver is performed by a modification of the technique described by Kholi et al. (Kohli et al., Gastroenterology 116:168-78 (1999)). Briefly, rats are anesthetized by intramuscular injection of ketamine and xylazine. After a midline laparotomy the portal triad is exposed and all structures (hepatic artery, portal vein and bile duct) to the left and median liver lobes are occluded with a soft vascular clamp for 85 minutes. Preservation of perfusion of the remaining liver prevents mesenteric venous congestion during ischemia. Immediately after reperfusion, the non-ischemic lobes (right and caudate) are removed by hepatectomy. Survival of the animals is dependent solely on the remaining 70% of the liver, which had been subjected to the ischemic injury. This model allows for maintenance of portal decompression while the liver is rendered ischemic and thus avoids both the use of temporary portacaval bypass and production of intestinal congestion. Animals surviving for 7 days after surgery are considered survivors. A JNK Inhibitor is administered prior to the onset of surgery.

5.4 Detection of Phosphorylated C-JUN

Human umbilical vein endothelial cells (HUVEC) are cultured to 80% confluency and then pre-treated with a JNK Inhibitor (30 μM) at a final concentration of 0.5% DMSO. After 30 minutes, cells are stimulated with TNFα (30 ng/ml) for 20 minutes. Cells are washed, scraped from the plate, lyzed with 2× Laemmli buffer and heated to 100° C. for 5 minutes. Whole cell lysate (approx. 30 μg) is fractionated on Tris-glycine buffered 10% SDS-polyacrylamide gels (Novex, San Diego, Calif.) and transferred to nitrocellulose membrane (Amersham, Piscataway, N.J.). Membranes are blocked with 5% non-fat milk powder (BioRad, Hercules, Calif.) and incubated with antibody to phospho-c-Jun (1:1000 #91645) (New England Biolabs, Beverly, Mass.) and then donkey anti-rabbit horse radish peroxidase conjugated antibody (1:2500) (Amersham) in phosphate buffered saline with 0.1% Tween-20 and 5% non-fat milk powder. Immunoreactive proteins are detected with chemiluminescence and autoradiography (Amersham). In one embodiment, the JNK Inhibitor shows greater than 50% inhibition of c-Jun phosphorylation at 30 μm in this assay.

While the invention has been described with respect to the particular embodiments, it will be apparent to those skilled in the art that various changes and modifications can be made without departing from the spirit and scope of the invention as defined in the claims. Such modifications are also intended to fall within the scope of the appended claims.

1. A method for preserving tissue, comprising contacting ex vivo tissue with an effective amount of a JNK Inhibitor.

2. The method of claim 1, wherein the tissue is heart, lung, intestine, kidney, liver or pancreas.

3. The method of claim 1, further comprising implanting the contacted tissue in a recipient.

4. A method for preserving tissue, comprising contacting ex vivo tissue with an effective amount of a compound of formula (I): 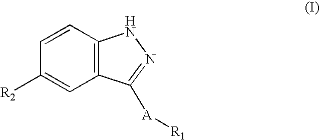
or a pharmaceutically acceptable salt thereof,
wherein:
A is a direct bond, —(CH₂)ₐ—, —(CH₂)_{b}CH═CH(CH₂)_{c}—, or —(CH₂)_{b}C≡C(CH₂)_{c}—;
R₁ is aryl, heteroaryl or heterocycle fused to phenyl, each being optionally substituted with one to four substituents independently selected from R₃;
R₂ is —R₃, —R₄, —(CH₂)_{b}C(═O)R₅, —(CH₂)_{b}C(═O)OR₅, —(CH₂)_{b}C(═O)NR₅R, —(CH₂)_{b}C(═O)NR₅(CH₂)_{c}C(═O)R₆, —(CH₂)_{b}NR₅C(═O)R₆, —(CH₂)_{b}NR₅C(═O)NR₆R₇, —(CH₂)_{b}NR₅R₆, —(CH₂)_{b}OR₅, —(CH₂)_{b}SO_{d}R₅ or —(CH₂)_{b}SO₂NR₅R₆;
a is 1, 2, 3, 4, 5 or 6;
b and c are the same or different and at each occurrence independently selected from 0, 1, 2, 3 or 4;
d is at each occurrence 0, 1 or 2;
R₃ is at each occurrence independently halogen, hydroxy, carboxy, alkyl, alkoxy, haloalkyl, acyloxy, thioalkyl, sulfinylalkyl, sulfonylalkyl, hydroxyalkyl, aryl, arylalkyl, heterocycle, heterocycloalkyl, —C(═O)OR₈, —OC(═O)R₈, —C(═O)NR₈R₉, —C(═O)NR₈OR₉, —SO₂NR₈R₉, —NR₈SO₂R₉, —CN, —NO₂, —NR₈R₉, —NR₈C(═O)R₉, —NR₈C(═O)(CH₂)_{b}OR₉, —NR₈C(═O)(CH₂)_{b}R₉, NR₈C(═O)(CH₂)N₈R₉, —O(CH₂)_{b}NR₈R₉, or heterocycle fused to phenyl;
R₄ is alkyl, aryl, arylalkyl, heterocycle or heterocycloalkyl, each being optionally substituted with one to four substituents independently selected from R₃, or R₄ is halogen or hydroxy;
R₅, R₆ and R₇ are the same or different and at each occurrence independently hydrogen, alkyl, aryl, arylalkyl, heterocycle or heterocycloalkyl, wherein each of R₅, R₆ and R₇ are optionally substituted with one to four substituents independently selected from R₃; and
R₈ and R₉ are the same or different and at each occurrence independently hydrogen, alkyl, aryl, arylalkyl, heterocycle, or heterocycloalkyl, or R₈ and R₉ taken together with the atom or atoms to which they are bonded form a heterocycle, wherein each of R₈, R₉, and R₈ and R₉ taken together to form a heterocycle are optionally substituted with one to four substituents independently selected from R₃.

5. The method of claim 4, wherein the tissue is heart, lung, intestine, kidney, liver or pancreas.

6. A method for preserving tissue, comprising contacting ex vivo tissue with an effective amount of a compound of formula (II): 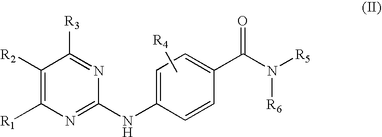
or a pharmaceutically acceptable salt thereof,
wherein:
R₁ is aryl or heteroaryl optionally substituted with one to four substituents independently selected from R₇;
R₂ is hydrogen;
R₃ is hydrogen or lower alkyl;
R₄ represents one to four optional substituents, wherein each substituent is the same or different and independently selected from halogen, hydroxy, lower alkyl and lower alkoxy;
R₅ and R₆ are the same or different and independently —R₈, —(CH₂)ₐC(═O)R₉, —(CH₂)ₐC(═O)OR₉, —(CH₂)ₐC(═O)NR₉R₁₀, —(CH₂)ₐC(═O)NR₉(CH₂)_{b}C(═O)R₁₀, (CH₂)ₐNR₉C(═O)R₁₀, (CH₂)ₐNR₁₁C(═O)NR₉R₁₀, (CH₂)ₐNR₉R₁₀, —(CH₂)ₐOR₉, —(CH₂)ₐSO_{c}R₉ or —(CH₂)ₐSO₂NR_{g}R₁₀;
or R₅ and R₆ taken together with the nitrogen atom to which they are attached to form a heterocycle or substituted heterocycle;
R₇ is at each occurrence independently halogen, hydroxy, cyano, nitro, carboxy, alkyl, alkoxy, haloalkyl, acyloxy, thioalkyl, sulfinylalkyl, sulfonylalkyl, hydroxyalkyl, aryl, arylalkyl, heterocycle, substituted heterocycle, heterocycloalkyl, —C(═O)OR₈, —OC(═O)R₈, —C(═O)NR₈R₉, —C(═O)NR₈OR₉, —SO_{c}R₈, —SO_{c}NR₈R₉, —NR₈SO_{c}R₉, —NR₈R₉, —NR₈C(═O)R₉, —NR₈C(═O)(CH₂)_{b}OR₉, —NR₈C(═O)(CH₂)_{b}R₉, —O(CH₂)_{b}NR₈R₉, or heterocycle fused to phenyl;
R₈, R₉, R₁₀ and R₁₁ are the same or different and at each occurrence independently hydrogen, alkyl, aryl, arylalkyl, heterocycle, heterocycloalkyl;
or R₈ and R₉ taken together with the atom or atoms to which they are attached to form a heterocycle;
a and b are the same or different and at each occurrence independently selected from 0, 1, 2, 3 or 4; and
c is at each occurrence 0, 1 or 2.

7. The method of claim 6, wherein the tissue is heart, lung, intestine, kidney, liver or pancreas.

8. A method for preserving tissue, comprising contacting ex vivo tissue with an effective amount of a compound of formula(III): 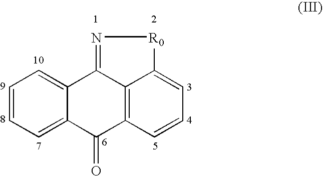
or a pharmaceutically acceptable salt thereof,
wherein R₀ is —O—, —S—, —S(O)—, —S(O)₂—, NH or —CH₂—;
the compound of structure (III) being: (i) unsubstituted, (ii) monosubstituted and having a first substituent, or (iii) disubstituted and having a first substituent and a second substituent;
the first or second substituent, when present, is at the 3, 4, 5, 7, 8, 9, or 10 position, wherein the first and second substituent, when present, are independently alkyl, hydroxy, halogen, nitro, trifluoromethyl, sulfonyl, carboxyl, alkoxycarbonyl, alkoxy, aryl, aryloxy, arylalkyloxy, arylalkyl, cycloalkylalkyloxy, cycloalkyloxy, alkoxyalkyl, alkoxyalkoxy, aminoalkoxy, mono-alkylaminoalkoxy, di-alkylaminoalkoxy, or a group represented by structure (a), (b), (c), (d), (e), or (f): 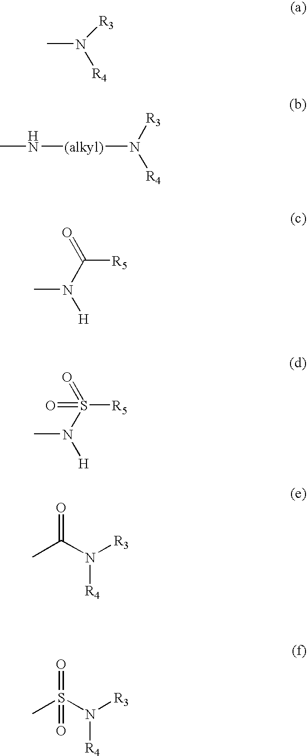
wherein R₃ and R₄ are taken together and represent alkylidene or a heteroatom-containing cyclic alkylidene or R₃ and R₄ are independently hydrogen, alkyl, cycloalkyl, aryl, arylalkyl, cycloalkylalkyl, aryloxyalkyl, alkoxyalkyl, aminoalkyl, mono-alkylaminoalkyl, or di-alkylaminoalkyl; and
R₅ is hydrogen, alkyl, cycloalkyl, aryl, arylalkyl, cycloalkylalkyl, alkoxy, alkoxyalkyl, alkoxycarbonylalkyl, amino, mono-alkylamino, di-alkylamino, arylamino, arylalkylamino, cycloalkylamino, cycloalkylalkylamino, aminoalkyl, mono-alkylaminoalkyl, or di-alkylaminoalkyl.

9. The method of claim 8, wherein the tissue is heart, lung, intestine, kidney, liver or pancreas.

10. A method for preventing reperfusion injury to implanted tissue, comprising: (a) contacting tissue with an effective amount of a JNK Inhibitor; and (b) implanting the tissue in a recipient.

11. The method of claim 10, further comprising contacting the tissue with an effective amount of an immunosuppressant.

12. The method of claim 10, further comprising contacting the tissue with an effective amount of an antibiotic.

13. A method for preventing transplant rejection, comprising: (a) administering to a transplant recipient in need thereof an effective amount of a JNK Inhibitor; and (b) transplanting the tissue in a recipient.

14. A method for preserving tissue, comprising: (a) administering an effective amount of a JNK Inhibitor to a tissue donor; and (b) removing the tissue from the donor.

15. A method for preserving a cell to be implanted, comprising: (a) contacting a cell with an effective amount of a JNK Inhibitor; and (b) implanting the contacted cell in a recipient.

16. A method for preventing ischemia-reperfusion injury that occurs during or as a result of surgery or trauma, comprising administering an effective amount of a JNK Inhibitor to a patient in need thereof.

17. A method for preserving an organ to be implanted, comprising: (a) contacting an organ with an effective amount of a JNK Inhibitor; and (b) implanting the contacted organ in a recipient.

18. The method of claim 17, wherein the organ is a heart, kidney, liver or lung.

19. A composition comprising ex vivo tissue and an effective amount of a JNK Inhibitor for preserving the tissue.

20. The composition of claim 19, further comprising an effective amount of another tissue-preservation agent for preserving the tissue.

21. The composition of claim 20, wherein the tissue-preservation agent is a macromolecule of molecular weight greater than 20,000 daltons, D-Glucose, a magnesium ion, a potassium ion, adenosine, an antioxidant, a reducing agent, an agent that prevents calcium entry into a cell, a vasodilator, an anticoagulant, a bacteriostat or an amiloride containing compound.

22. A container containing the composition of claim 19.
